(19) United States
(12) Patent Application Publication
(10) Pub. No.: US 2026/0219603 A1
(43) Pub. Date: Jul. 30, 2026

(54) IMAGE FORMING APPARATUS

(71) Applicant: CANON KABUSHIKI KAISHA, Tokyo (JP)

(72) Inventor: SHIGEKI TAKISHITA, Ibaraki (JP)

(21) Appl. No.: 19/457,496

(22) Filed: Jan. 23, 2026

(30) Foreign Application Priority Data
Jan. 25, 2025 (JP) 2025-011011

(51) Int. Cl. G03G 15/16; G03G 15/00; G03G 15/01

(52) U.S. Cl. CPC G03G 15/161; G03G 15/0131; G03G 15/0189; G03G 15/1615; G03G 15/5004; G03G 15/55; G03G 15/80

(57) ABSTRACT

An image forming apparatus includes a photosensitive member, an intermediary transfer belt, a primary transfer member, an electrode, a power source to apply a bias of the same polarity as a charging polarity to the electrode, an inner surface cleaning member to remove an adhering material from an inner surface of the intermediary transfer belt and a contact/separation mechanism to move the electrode between a first position to be in contact with the inner surface of the intermediary transfer belt and a second position not to be in contact with the inner surface of the intermediary transfer belt. A controller controls so as to start rotation of the intermediary transfer belt in a state in which the electrode is caused to be in the second position when the controller causes the intermediary transfer belt to be rotated from a state in which the intermediary transfer belt is stopped.

### BACKGROUND

### Field of the Technology

The present invention relates to an image forming apparatus such as a copy machine, a printer and a facsimile device, or a multifunction machine provided with a plurality of these functions, using an electrophotographic type or an electrostatic recording type.

### Description of the Related Art

As an image forming apparatus such as a color copying machine, a color printer and a color multifunction machine using an electrophotographic type, since it has advantages such that it is relatively easy for downsizing an apparatus main assembly, and for adopting the image forming apparatus to various types of recording material, an image forming apparatus which employs an intermediary transfer type is becoming mainstream. The image forming apparatus of the intermediary transfer type is, generally, configured to include a plurality of photosensitive drums and an intermediary transfer belt.

In such an image forming apparatus, toner images formed on the plurality of photosensitive drums are primarily transferred electrostatically onto the intermediary transfer belt sequentially in a primary transfer portion, respectively. In addition, the toner image primarily transferred onto the intermediary transfer belt is secondarily transferred electrostatically onto a recording material such as a paper in a secondary transfer portion. Incidentally, with respect to arrangement of members around the primary transfer portion, etc., an upstream and a downstream refer to, unless otherwise particularly mentioned, an upstream and a downstream in a conveyance direction of the intermediary transfer belt.

For toner on the intermediary transfer belt, in the downstream of the primary transfer portion, by being subjected to electric discharge between the intermediary transfer belt and the photosensitive drum, a charge amount thereof tends to be increased. And by the charge amount of the toner on the intermediary transfer belt being increased, it may become difficult to transfer the toner to the recording material in the secondary transfer portion. For example, uniform transfer of the toner to an embossed paper, which has unevenness on a surface thereof, etc. becomes difficult. Particularly, the transfer of the toner image to a recessed portion of the embossed paper is likely to become difficult since a gap is generated between the intermediary transfer belt and the embossed paper in the secondary transfer portion so that a relatively large transfer electric field is required.

Here, in Japanese Patent Application Laid-Open No. 2003-57963, a configuration, in which a conductive contact plate is provided on a downstream of a primary transfer portion and on an inner peripheral surface side of an intermediary transfer belt, and a bias of the same polarity as charging polarity of a photosensitive drum is applied to this contact plate, is disclosed.

In order to suppress the increase of the charge amount of the toner in the downstream of the primary transfer portion as described above, it is effective to suppress the electric discharge in the downstream of the primary transfer portion. In addition, in order to suppress the electric discharge, it is effective to dispose a conductive electrode member on the downstream of the primary transfer portion and on an inner peripheral surface side of the intermediary transfer belt, and to apply a bias of the same polarity as charging polarity of the photosensitive drum to the electrode member. Particularly, it is effective to dispose the electrode member in contact with the inner peripheral surface of the intermediary transfer belt, and to apply a voltage of the same polarity as the charging polarity of the photosensitive drum to the electrode member.

However, in the configuration provided with the electrode member described above, since the electrode member contacts the inner peripheral surface of the intermediary transfer belt, the electrode member may scrape off adhering material (foreign matter), which is adhered to the inner peripheral surface of the intermediary transfer belt. As the adhering material, which is adhered to the inner peripheral surface of the intermediary transfer belt, for example, one derived from an oozing matter from a primary transfer roller and/or a secondary transfer inner roller may be exemplified. And when such a material is adhered to the electrode member exceeding an allowable range, there is a possibility that the ability of the electrode member to suppress the electric discharge described above is decreased.

### SUMMARY

Therefore, an object of the present invention is to reduce adhesion of adhering material to an electrode member disposed on a downstream of a primary transfer portion and on an inner peripheral surface side of an intermediary transfer belt.

The object described above is achieved by an image forming apparatus according to the present invention. In summary, according to the present invention, there is provided an image forming apparatus comprising: a photosensitive member capable of being electrically charged to a predetermined polarity and configured to bear a toner image; an intermediary transfer belt stretched by a plurality of stretching rollers, configured to convey the toner image, primarily transferred from the photosensitive member in a primary transfer portion which is in contact with the photosensitive member, to secondarily transfer the toner image onto a recording material in a secondary transfer portion, and capable of being circulated and moved; a primary transfer member configured to form the primary transfer portion by being in contact with an inner surface of the intermediary transfer belt, and configured to transfer the toner image from the photosensitive member onto the intermediary transfer belt in the primary transfer portion under application of a bias; an electrode member provided on a side downstream of the primary transfer portion with respect to a movement direction of the intermediary transfer belt so as to be in contact with an inner surface of the intermediary transfer belt; a power source configured to apply a bias of the same polarity as the predetermined polarity to the electrode member; an inner surface cleaning member in contact with the inner surface of the intermediary transfer belt at an inner surface cleaning portion and configured to remove an adhering material from the inner surface of the intermediary transfer belt; a driving portion configured to drive the intermediary transfer belt; a contact/separation mechanism configured to move the electrode member between a first position to be in contact with the inner surface of the intermediary transfer belt and a second position not to be in contact with the inner surface of the intermediary transfer belt; and a controller configured to control the driving portion and the contact/separation mechanism, wherein the controller controls so as to start rotation of the intermediary transfer belt in a state in which the electrode member is caused to be in the second position when the controller causes the intermediary transfer belt to be rotated from a state in which the intermediary transfer belt is stopped.

Further features of the present invention will become apparent from the following description of exemplary embodiments with reference to the attached drawings.

### BRIEF DESCRIPTION OF THE DRAWINGS

FIG. 1 is a cross-sectional outline view of an image forming apparatus.

FIG. 2 is an outline block diagram of a control system of the image forming apparatus.

FIG. 3, part (a) and part (b), includes schematic cross-sectional views of a belt cleaning device.

FIG. 4, part (a) and part (b), includes a cross-sectional view and a perspective view of a potential regulating member.

FIG. 5 is a cross-sectional view of another example of the potential regulating member.

FIG. 6 is a cross-sectional view of another example of the potential regulating member.

FIG. 7 is a cross-sectional view to describe a disposition of the potential regulating member.

FIG. 8 is a cross-sectional view to describe the disposition of the potential regulating member.

FIG. 9 is a cross-sectional view to describe the disposition of the potential regulating member.

FIG. 10, part (a) and part (b), includes schematic cross-sectional views to describe a supporting configuration for a primary transfer roller.

FIG. 11, part (a) and part (b), includes schematic cross-sectional views to describe a supporting configuration for the potential regulating member.

FIG. 12 is a cross-sectional outline view to describe a configuration and a disposition of a scraper unit.

FIG. 13 is a cross-sectional outline view to describe the configuration and the disposition of the scraper unit.

FIG. 14 is a cross-sectional outline view to describe the configuration and the disposition of the scraper unit.

FIG. 15 is a flowchart diagram to describe an operation during turning a power source on in a Comparative Example.

FIG. 16 is a flowchart diagram to describe an inner surface cleaning operation during turning the power source on in an Embodiment.

FIG. 17 is a flowchart diagram to describe the inner surface cleaning operation during executing a job in the Embodiment.

FIG. 18 is a schematic view of an operating screen for an inner surface cleaning mode.

FIG. 19 is a flowchart diagram to describe an operation of the inner surface cleaning mode.

FIG. 20 is a view showing results of an evaluation experiment.

FIG. 21 is a view showing results of the evaluation experiment.

### DESCRIPTION OF THE EMBODIMENTS

Hereinafter, an image forming apparatus according to the present invention will be described in more detail according to the drawings.

### Embodiment 1

### 1. Overall configuration and operation of the image forming apparatus

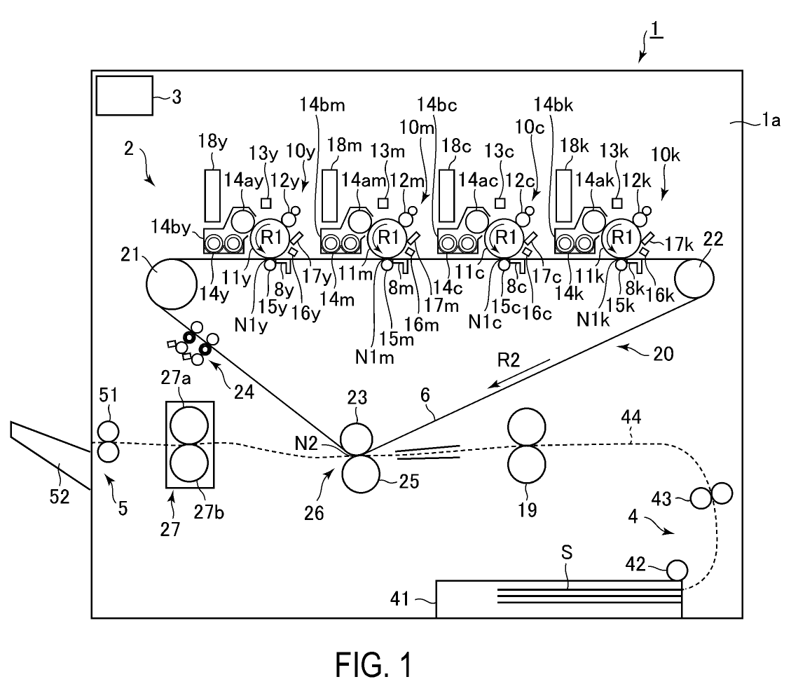

First, an overall configuration and an operation of the image forming apparatus in the present Embodiment will be described. FIG. 1 is a cross-sectional outline view of an image forming apparatus 1 in the present Embodiment. The image forming apparatus 1 in the present Embodiment is a full-color printer of tandem type, which is capable of forming a full-color image on a recording material S having a sheet shape using an electrophotographic type and employs an intermediary transfer type.

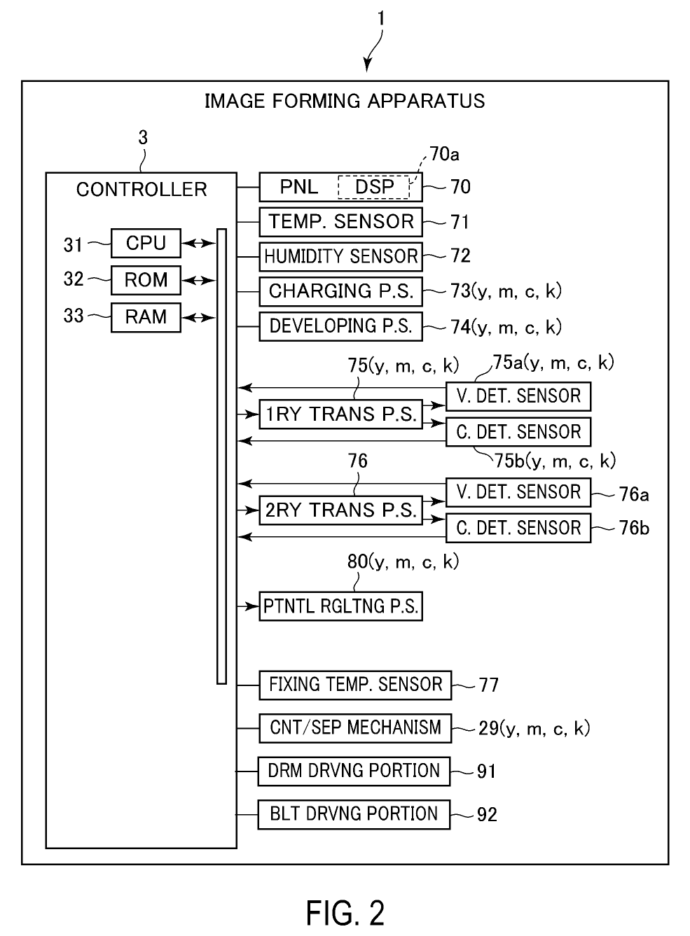

The image forming apparatus 1 includes a printer portion (engine) 2, a control portion 3, a feeding portion 4 for the recording material S, and a discharging portion 5 for the recording material S. In addition, inside the image forming apparatus 1, a temperature sensor 71 (FIG. 2), which is capable of detecting a temperature inside the apparatus, and a humidity sensor 72 (FIG. 2), which is capable of detecting a humidity inside the apparatus, are provided. The image forming apparatus 1 is capable of forming the image on the recording material S based on image information (image signal) acquired by an original reading apparatus (not shown), which is provided to the image forming apparatus 1 or connected to the image forming apparatus 1. In addition, the image forming apparatus 1 is capable of forming the image on the recording material S based on the image information (image signal) from an external device (not shown) such as a personal computer (host device), a digital camera and a smartphone, which is connected to the image forming apparatus 1. Incidentally, the recording material (a transfer material, a recording medium, a sheet) S is one on which the image is formed by toner. Specific examples of the recording material S include a plain paper, a thick paper, a gloss coated paper, a mat coated paper, an embossed paper, or a sheet made of a synthetic resin (synthetic paper) and a sheet for an overhead projector (resin film), which are substitute for the plain paper, etc. Here, the recording material S may be referred to as a “paper” (“paper”, “embossed paper”, “high resistance paper”, etc.), however, in those cases, the recording material S still includes one made of material other than paper or material including material other than paper.

The printer portion 2 forms the image on the recording material S fed from the feeding portion 4 based on the image information. The printer portion 2 includes image forming units (image forming portions) 10y, 10m, 10c and 10k, toner bottles 18y, 18m, 18c and 18k, an intermediary transfer unit 20, a secondary transfer device 26 and a fixing device 27. The image forming units 10y, 10m, 10c and 10k form toner images of each color of yellow (y), magenta (m), cyan (c) and black (k), respectively. Incidentally, elements having the same or corresponding functions or configurations, which are provided for each color, may be described collectively by omitting the y, m, c and k at ends of the reference numerals, which indicate that the element is for either one of the colors. In addition, the image forming apparatus 1 is capable of forming, by using the image forming units 10 for a desired single color or some colors of the four colors, a single color image such as the image of a single color of black, or a multi-color image.

The image forming unit 10 includes a photosensitive drum 11 (11y, 11m, 11c, 11k), which is a photosensitive member (electrophotographic photosensitive member) having a drum shape (cylindrical shape), as an image bearing member. In addition, the image forming unit 10 includes a charging roller 12 (12y, 12m, 12c, 12k), which is a charging member having a roller shape, as a charging means. In addition, the image forming unit 10 includes an exposure device 13 (13y, 13m, 13c, 13k) as an exposure means. In addition, the image forming unit 10 includes a developing device 14 (14y, 14m, 14c, 14k) as a developing means. In addition, the image forming unit 10 includes a pre-exposure device 16 (16y, 16m, 16c, 16k) as an electric charge eliminating means. In addition, the image forming unit 10 includes a drum cleaning device 17 (17y, 17m, 17c, 17k) as a photosensitive member cleaning means. The image forming unit 10 forms the toner image on the photosensitive drum 11. The toner image formed on the photosensitive drum 11 is transferred to an intermediary transfer belt 6, which will be described below.

The photosensitive drum 11 is movable (rotatable) with bearing an electrostatic image (electrostatic latent image) and the toner image. In the present Embodiment, the photosensitive drum 11 is a negatively charged organic photosensitive conductor (OPC) having an outer diameter of 30 mm. This photosensitive drum 11 includes a cylinder made of aluminum as a base body, and a surface layer formed on a surface of the base body. In the present Embodiment, as the surface layer, three layers of an undercoat layer, a photoelectric charge generating layer and an electric charge transporting layer, which are applied and laminated in this order on the base body, are included. When an image forming operation is started, the photosensitive drum 11 is rotationally driven, by driving force transmitted from a driving motor of a drum driving portion 91 (FIG. 2) as a driving means, in a direction of an arrow R1 in FIG. 1 (counterclockwise direction) at a predetermined peripheral speed (process speed).

A surface of the rotating photosensitive drum 11 is uniformly charged by the charging roller 12. In the present Embodiment, the charging roller 12 is a rubber roller, which contacts the surface of the photosensitive drum 11 and is driven and rotated by the rotation of the photosensitive drum 11. To the charging roller 12, a charging power source 73 (73y, 73m, 73c, 73k) (FIG. 2) as a charging bias applying means (charging bias applying portion) is connected. During the charging process, the charging power source 73 applies, to the charging roller 12, a predetermined charging bias (charging voltage).

The surface of the photosensitive drum 11, which has been subjected to the charging process, is scanned and exposed by the exposure device 13 based on the image information, and the electrostatic image is formed on the photosensitive drum 11. In the present Embodiment, the exposure device 13 is a laser scanner. The exposure device 13 emits a laser beam according to the image information of separated colors, which is output from the control portion 3, and scans and exposes the surface (an outer peripheral surface) of the photosensitive drum 11.

The electrostatic image formed on the photosensitive drum 11 is developed (visualized) by the toner being supplied by the developing device 14, and the toner image (developer image) is formed on the photosensitive drum 11. In the present Embodiment, the developing device 14 is a two-component developing device which uses a two-component developer including the toner (non-magnetic toner particle) as developer and a carrier (magnetic carrier particle). In a developing container (developing container main body) 14b of the developing device 14, the two-component developer is accommodated, and the toner of an amount corresponding to consumed toner is supplied from the toner bottle 18. The developing device 14 includes a developing sleeve 14a as a developing member (developer carrying member). Inside the developing sleeve 14a, a magnet roller (not shown), which is a magnet having a roller shape, as a magnetic field generating means (magnetic field generating member) is fixedly disposed so as not to be rotated with respect to the developing container 14b. The developing sleeve 14a carries the two-component developer, and conveys the developer to a developing area opposite to the photosensitive drum 11. And in the developing area, from the two-component developer on the developing sleeve 14a to an image portion of the electrostatic image on the photosensitive drum 11, the toner is moved and adhered. To the developing sleeve 14a, a developing power source 74 (74y, 74m, 74c, 74k) (FIG. 2) as a developing bias applying means (developing bias applying portion) is connected. During development, the developing power source 74 applies, to the developing sleeve 14a, a predetermined developing bias (developing voltage). In the present Embodiment, to an exposed portion (the image portion) on the photosensitive drum 11, of which an absolute value of a potential is decreased by being exposed after having been uniformly charged, the toner charged to the same polarity as charging polarity of the photosensitive drum 11 (in the present Embodiment, negative polarity) is adhered (reverse development type). In the present Embodiment, normal charging polarity of the toner, which is main charging polarity of the toner during development, is negative polarity.

So as to be opposite to the four photosensitive drums 11y, 11m, 11c and 11k, the intermediary transfer unit 20 is disposed. The intermediary transfer unit 20 includes the intermediary transfer belt 6 constituted by an endless belt as an intermediary transfer member. The intermediary transfer belt 6 is stretched by being wound around a driving roller 21, a tension roller 22 and a secondary transfer inner roller 23 as a plurality of stretching rollers. The intermediary transfer belt 6 is movable (rotatable) with bearing the toner image.

The driving roller 21 is rotationally driven by driving force transmitted from a driving motor of a belt driving portion 92 (FIG. 2) as a driving means. The intermediary transfer belt 6 is rotationally driven (circularly moved), by the driving force being transmitted thereto by the driving roller 21 being rotationally driven, in a direction of an arrow R2 in FIG. 1 (clockwise direction) at a predetermined peripheral speed corresponding to the peripheral speed of the photosensitive drum 11. The tension roller 22 controls a tensile force of the intermediary transfer belt 6 constant. To the tension roller 22, by urging force of a tension spring (not shown) constituted by a compression coil spring which is an urging member as an urging means, force so as to push out the intermediary transfer belt 6 from an inner peripheral surface (back surface) side to an outer peripheral surface (front surface) side is applied. By this force, to the intermediary transfer belt 6, the tensile force of about 2 kgf through 5 kgf is applied in a conveyance direction (process proceeding direction, movement direction) thereof. The secondary transfer inner roller 23 constitutes, together with a secondary transfer outer roller 25, which will be described below, the secondary transfer device 26. On the inner peripheral surface side of the intermediary transfer belt 6, corresponding to respective photosensitive drums 11y, 11m, 11c and 11k, primary transfer rollers 15y, 15m, 15c and 15k, which are primary transfer members having a roller shape as primary transfer means, are disposed, respectively. In the present Embodiment, the primary transfer roller 15 is disposed opposite to the photosensitive drum 11, and nips the intermediary transfer belt 6 between the photosensitive drum 11. The primary transfer roller 15 is pressed toward the photosensitive drum 11, is in contact with the photosensitive drum 11 via the intermediary transfer belt 6, and forms a primary transfer portion (primary transfer nip portion) N1, which is a contact portion between the photosensitive drum 11 and the intermediary transfer belt 6. The driving roller 21 and the secondary transfer inner roller 23 include a core metal, and an elastic layer formed around the core metal, respectively, and EPDM rubber (ethylene propylene diene rubber) is used as material for the elastic layer. The stretching rollers other than the driving roller 21 and each primary transfer roller 15 are rotated driven by the rotation of the intermediary transfer belt 6. Incidentally, a number of the stretching rollers is not limited to the number in the present Embodiment, but may be more, for example.

The toner image formed on the photosensitive drum 11 is transferred (primarily transferred), in the primary transfer portion N1, by an action of the primary transfer roller 15, onto the rotating intermediary transfer belt 6. For example, during formation of the full-color image, the toner images of respective colors of yellow, magenta, cyan and black, which are formed on respective photosensitive drums 11, are multiply transferred so as to be sequentially superimposed onto the intermediary transfer belt 6. To the primary transfer roller 15, a primary transfer power source 75 (75y, 75m, 75c, 75k) (FIG. 2) as a primary transfer bias applying means (primary transfer bias applying portion) is connected. During primary transfer, the primary transfer power source 75 applies, to the primary transfer roller 15, a primary transfer bias (primary transfer voltage), which is direct current voltage having opposite polarity to the normal charging polarity of the toner (in the present Embodiment, positive polarity). As a result, the toner image constituted by the toner having negative polarity on the photosensitive drum 11 is primarily transferred onto the intermediary transfer belt 6.

To the primary transfer power source 75, a voltage detecting sensor 75a (FIG. 2) as a voltage detecting means (voltage detecting portion), which detects an output voltage of the primary transfer power source 75, and a current detecting sensor 75b (FIG. 2) as a current detecting means (current detecting portion), which detects an output current of the primary transfer power source 75, are connected. In the present Embodiment, the primary transfer bias of about 1 kV through 2 kV, for example, is applied to the primary transfer roller 15 (“through” indicates a range including values before and after thereof. The same applies hereinafter.). In addition, in the present Embodiment, during primary transfer, the primary transfer bias is put under a constant voltage control. In the present Embodiment, the primary transfer power sources 75y, 75m, 75c and 75k are provided independently to each of the primary transfer rollers 15y, 15m, 15c and 15k, respectively. And in the present Embodiment, the primary transfer voltages applied to each of the primary transfer rollers 15y, 15m, 15c and 15k can be individually controlled.

Here, in the present Embodiment, the primary transfer roller 15 includes a core metal, and an elastic layer of an ion-conductive foam rubber (NBR (nitrile rubber) + ECO rubber (epichlorohydrin rubber)) formed around the core metal. An outer diameter of the primary transfer roller 15 is, for example, 15 mm through 20 mm. In addition, for the primary transfer roller 15, a roller of which an electrical resistance value is 1 × 10⁵ Ω through 1 × 10⁸ Ω (measured at N/N (23 °C, 50%RH), 1 kV applied) may be suitably used.

In addition, in the present Embodiment, the intermediary transfer belt 6 is an endless belt which includes a two-layer structure in which a base layer and a surface layer are laminated in this order from the inner peripheral surface side to the outer peripheral surface side. For material which constitutes the base layer, material which is resin such as polyimide and polycarbonate and in which an appropriate amount of carbon black as an antistatic agent is contained may be suitably used. A thickness of the base layer is, for example, 0.05 mm through 0.15 mm. In addition, for material which constitutes the surface layer, CR rubber (chloroprene rubber), etc., to which conductivity is imparted by carbon black, may be suitably used. A thickness of the surface layer is, for example, 0.200 mm through 0.300 mm. In the present Embodiment, a volume resistivity of the intermediary transfer belt 6 is 5 x 10⁸ Ω cm through 1 x 10¹⁴ Ω cm (23 °C, 50%RH). Incidentally, the intermediary transfer belt 6 has the two-layer structure in the present Embodiment, however, for example, the intermediary transfer belt 6 may have a single-layer structure with the material corresponding to the base layer described above. In addition, the surface layer may be configured to be a resin coated layer, which has a thickness of about 0.002 mm through 0.01 mm and includes a fluororesin and/or silicon. In addition, the intermediary transfer belt 6 may have a multi-layer structure of three or more layers.

On the outer peripheral surface side of the intermediary transfer belt 6, the secondary transfer outer roller 25, which is a secondary transfer member having a roller shape as a secondary transfer means, is disposed. The secondary transfer outer roller 25 as the secondary transfer member constitutes, together with the secondary transfer inner roller 23 as an opposite member (opposite electrode), the secondary transfer device 26. The secondary transfer outer roller 25 is pressed toward the secondary transfer inner roller 23, is in contact with the secondary transfer inner roller 23 via the intermediary transfer belt 6, and forms a secondary transfer portion (secondary transfer nip portion) N2, which is a contacting portion between the intermediary transfer belt 6 and the secondary transfer outer roller 25. The toner image formed on the intermediary transfer belt 6 is transferred (secondarily transferred), in the secondary transfer portion N2, by an action of the secondary transfer device 26, onto the recording material S, which is nipped and conveyed by the intermediary transfer belt 6 and the secondary transfer outer roller 25. To the secondary transfer outer roller 25, a secondary transfer power source 76 (FIG. 2) as a secondary transfer bias applying means (secondary transfer bias applying portion) is connected. During secondary transfer, the secondary transfer power source 76 applies, to the secondary transfer outer roller 25, a secondary transfer bias (secondary transfer voltage), which is direct current voltage having opposite polarity to the normal charging polarity of the toner (in the present Embodiment, positive polarity). As a result, the toner image constituted by the toner having negative polarity on the intermediary transfer belt 6 is secondarily transferred onto the recording material S. To the secondary transfer power source 76, a voltage detecting sensor 76a (FIG. 2) as a voltage detecting means (voltage detecting portion), which detects an output voltage of the secondary transfer power source 76, and a current detecting sensor 76b (FIG. 2) as a current detecting means (current detecting portion), which detects an output current of the secondary transfer power source 76, are connected. In addition, a core metal of the secondary transfer inner roller 23 is connected to a ground potential (electrically grounded). In the present Embodiment, for example, by the secondary transfer bias of about 1 kV through 6.5 kV being applied to the secondary transfer outer roller 25, and a secondary transfer current of about 15 μA through 100 μA being caused to flow to the secondary transfer portion N2, the toner image on the intermediary transfer belt 6 is secondarily transferred onto the recording material S. In the present Embodiment, during secondary transfer, the secondary transfer bias is put under constant voltage control. Incidentally, it may be configured that the secondary transfer bias, which is direct current voltage of the same polarity as the normal charging polarity of the toner, is applied from the secondary transfer power source 76 to the secondary transfer inner roller 23 as the secondary transfer member, and the secondary transfer outer roller 25 as the opposite member is connected to the ground potential.

The recording material S is conveyed, in parallel with the forming operation of the toner image to the intermediary transfer belt 6, from the feeding portion 4 toward the secondary transfer portion N2. The recording material S is accommodated in a cassette 41 as a recording material accommodating portion of the feeding portion 4. The recording materials S accommodated in the cassette 41 are separated one by one by a feeding roller 42, etc. as a feeding member of the feeding portion 4, and are sent out from the cassette 41. This recording material S is conveyed by a conveyance roller 43, etc. as a conveyance member of the feeding portion 4, to a registration roller 19 (registration roller pair) 19 as a conveyance member provided in a conveyance path 44 of the recording material S. And this recording material S is conveyed, by the registration roller 19, with timed with the toner image on the intermediary transfer belt 6, to the secondary transfer portion N2.

Here, in the present Embodiment, the secondary transfer outer roller 25 includes a core metal, and an elastic layer of an ion-conductive foam rubber (NBR + ECO rubber) formed around the core metal. An outer diameter of the secondary transfer outer roller 25 is, for example, 20 mm through 25 mm. In addition, as the secondary transfer outer roller 25, a roller of which an electric resistance value is 1 × 10⁵ Ω through 1 × 10⁸ Ω (measured at N/N (23°C, 50%RH) measurement, 1 kV applied) may be suitably used.

The recording material S, onto which the toner image has been transferred, is conveyed to the fixing device 27 as a fixing means. The fixing device 27 includes a fixing roller 27a and a pressing roller 27b. The fixing roller 27a incorporates a heater as a heating means. The pressing roller 27b forms a fixing portion (fixing nip portion) by being brought into a press contact with the fixing roller 27a. The fixing device 27 heats and presses the recording material S, which carries the unfixed toner image, by nipping and conveying the recording material S between the fixing roller 27a and the pressing roller 27b, and cause the toner image to be fixed (melted, stuck) onto the recording material S. Incidentally, a temperature (fixing temperature) of the fixing roller 27a is detected by a fixing temperature sensor 77 (FIG. 2). The recording material S, to which the toner image has been fixed, is conveyed in the discharging portion 5 by a discharging roller 51, etc., and is discharged (output) from a discharging port (not shown) onto a discharge tray 52 provided outside a main assembly 1a of the image forming apparatus 1.

The surface of the photosensitive drum 11 after the primary transfer is subjected to electric charge elimination by the pre-exposure device 16. In addition, the toner which remains on the photosensitive drum 11 without being transferred to the intermediary transfer belt 6 during primary transfer (primary transfer residual toner) is removed from the photosensitive drum 11 by the drum cleaning device 17, and is collected. In the present Embodiment, the drum cleaning device 17 scrapes off, with a cleaning blade as a cleaning member, the primary transfer residual toner from the surface of the rotating photosensitive drum 11, and collects the toner into a collecting container (not shown). The cleaning blade is a member having a plate shape, which is in contact with the photosensitive drum 11 with predetermined pressing force. The cleaning blade is in contact, so that a leading end on a free end portion side thereof faces an upstream side in a rotational direction of the photosensitive drum 11, with the surface of the photosensitive drum 11 in a counter direction with respect to the rotational direction of the photosensitive drum 11.

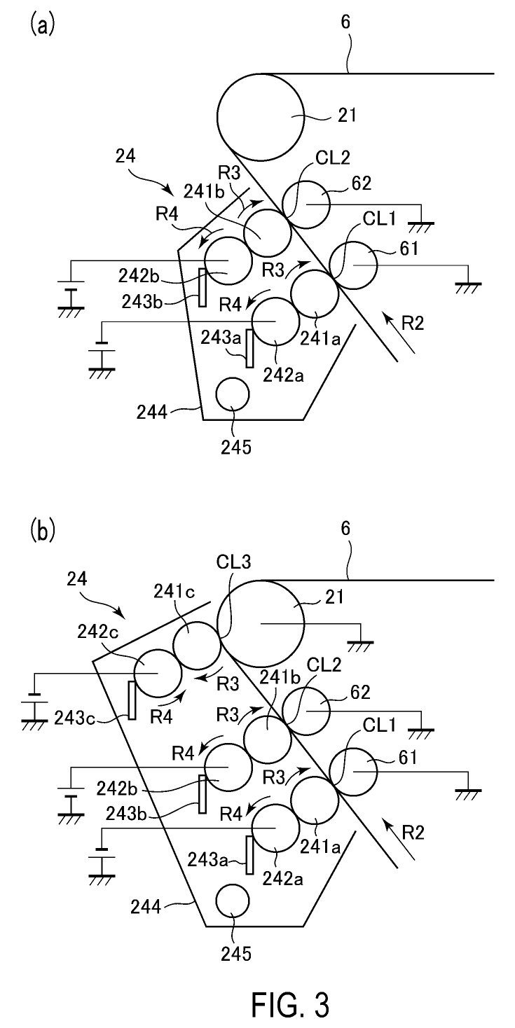

In addition, adhering material such as the toner which remains on the intermediary transfer belt 6 without being transferred to the recording material S during secondary transfer (secondary transfer residual toner) is removed from the intermediary transfer belt 6 by a belt cleaning device 24 as an intermediary transfer member cleaning means, and is collected. The belt cleaning device 24 is disposed, in the rotational direction of the intermediary transfer belt 6, on a downstream side of the secondary transfer portion N2 and on an upstream side of the primary transfer portion N1 (an upstreammost primary transfer portion N1Y). In the present Embodiment, for the belt cleaning device 24, an electrostatic cleaning method, which electrostatically collects the toner on the intermediary transfer belt 6, is employed. Here, with reference to part (a) and part (b) of FIG. 3, the belt cleaning device 24 will be further described. Part (a) and part (b) of FIG. 3 are schematic cross-sectional views each illustrating an example of a configuration of the belt cleaning device 24.

The belt cleaning device 24 shown in part (a) of FIG. 3 will be described. The belt cleaning device 24 includes a housing 244 disposed in a vicinity of the intermediary transfer belt 6. Inside the housing 244, a first and a second fur brushes 241a and 241b as a first and a second cleaning members, a first and a second bias rollers 242a and 242b as a first and a second collecting members, a first and a second blades 243a and 243b as a first and a second scraping members, and a collected toner screw 245 as a toner conveyance member are provided.

The first and the second fur brushes 241a and 241b are disposed so as to contact the intermediary transfer belt 6, respectively, and is rotated in a direction of an arrow R3 in part (a) of FIG. 3. At positions which are opposite to the first and the second fur brushes 241a and 241b via the intermediary transfer belt 6, a first and a second cleaning opposite rollers 61 and 62 are disposed, and the first and the second fur brushes 241a and 241b are in contact with the first and the second cleaning opposite rollers 61 and 62 via the intermediary transfer belt 6. A contact portion between the first fur brush 241a and the outer peripheral surface (outer surface) of the intermediary transfer belt 6 is a first cleaning portion CL1, and a contact portion between the second fur brush 241b and the outer peripheral surface (outer surface) of the intermediary transfer belt 6 is a second cleaning portion CL2. In the movement direction of the intermediary transfer belt 6, the first fur brush 241a is positioned on the upstream side of the second fur brush 241b. The first and the second bias rollers 242a and 242b are disposed so as to contact the first and the second fur brushes 241a and 241b, and are rotated in a direction of an arrow R4 in part (a) of FIG. 3, respectively. The first and the second blades 243a and 243b are disposed so as to be in contact with the first and the second bias rollers 242a and 242b, respectively.

The first and the second fur brushes 241a and 241b rub a surface of the intermediary transfer belt 6 by being rotated, respectively. In addition, to the first and the second fur brushes 241a and 241b, a predetermined cleaning bias (cleaning voltage) is applied via the first and the second bias rollers 242a and 242b. For example, the cleaning bias of negative polarity, which is the same polarity as the normal charging polarity of the toner, is applied to the first fur brush 241a, and the cleaning bias of positive polarity, which is the opposite polarity to the normal charging polarity of the toner, is applied to the second fur brush 241b. The first and the second cleaning opposite rollers 61 and 62 are connected to the ground potential. In this case, the toner having positive polarity on the surface of the intermediary transfer belt 6 is moved to the first fur brush 241a by being electrically attracted to the first fur brush 241a, and after being further moved to the first bias roller 242a, the toner is scraped off from the first bias roller 242a by the first blade 243a. In addition, the toner having negative polarity on the surface of the intermediary transfer belt 6 is moved to the second fur brush 241b by being electrically attracted to the second fur brush 241b, and after being further moved to the second bias roller 242b, the toner is scraped off from the second bias roller 242a by the second blade 243b. The toner scraped off from the first and the second bias rollers 242a and 242b is accommodated in the housing 244. The toner accommodated in the housing 244 is conveyed by the collected toner screw 245, is discharged from the housing 244, and is conveyed to and collected in a collected toner container (not shown) disposed in the image forming apparatus 1.

The belt cleaning device 24 shown in part (b) of FIG. 3 includes, in addition to the configuration of the belt cleaning device 24 shown in part (a) of FIG. 3, a third fur brush 241c, a third bias roller 242c and a third blade 243c. Configurations and functions of the third fur brush 241c, the third bias roller 242c and the third blade 243c are the same as those of the first fur brush 241a, the first bias roller 242a and the first blade 243a, for example. However, the third fur brush 241c is in contact with, via the intermediary transfer belt 6, the driving roller 21 which functions as an opposite roller thereof. A contact portion between the third fur brush 241c and the intermediary transfer belt 6 is a third cleaning portion CL3. In the movement direction of the intermediary transfer belt 6, the third fur brush 241c is positioned on the downstream side of the second fur brush 241b. To the third fur brush 241c, for example, the cleaning bias of negative polarity, which is the same polarity as the normal charging polarity of the toner, is applied.

Incidentally, in each image forming unit 10, for example, the photosensitive drum 11, the charging roller 12, the developing device 14, the pre-exposure device 16 and the drum cleaning device 17 may constitute a cartridge (process cartridge), which is integrally mountable to and demountable from the main assembly 1a. In addition, in the present Embodiment, the intermediary transfer unit 20 is constituted by the intermediary transfer belt 6, the stretching rollers of the intermediary transfer belt 6, the respective primary transfer rollers 15, the belt cleaning device 24, respective potential regulating members 8, which will be described below, etc. The intermediary transfer unit 20 may be configured to be integrally mountable to and demountable from the main assembly 1a.

### 2. Control configuration

FIG. 2 is a block diagram illustrating an outline configuration of a control system of the image forming apparatus 1 in the present Embodiment. To the image forming apparatus 1, the control portion 3 (control circuit) as a control means is provided. The control portion 3 is configured to include a CPU 31 as a calculation processing means (calculation processing portion), a ROM 32 and a RAM 33 as a storage means (storage portion), an input/output circuit (I/F) (not shown), which performs input/output of the signals between the control portion 3 and the external device, etc. The ROM 32 stores programs for controlling each portion of the image forming apparatus 1, etc. The RAM 33 temporarily stores data related to the control, etc. The CPU 31 is a microprocessor which manages overall control of the image forming apparatus 1, and is a main portion of a system controller. The CPU 31 is connected to each portion such as the feeding portion 4, the printer portion 2 and the discharging portion 5, exchanges signals with these each portion, and controls the operation of each portion. In the ROM 32, an image formation control sequence for forming the image on the recording material S, etc. is stored.

To the control portion 3, for example, the charging power source 73, the developing power source 74, the primary transfer power source 75, the secondary transfer power source 76, a potential regulating power source 80, which will be described below, etc. are connected, and these are controlled by signals from the control portion 3, respectively. Incidentally, although illustration is omitted, in the present Embodiment, the charging power source 73, the developing power source 74, the primary transfer power source 75 and the potential regulating power source 80 are independently provided to each image forming unit 10, respectively. In addition, to the control portion 3, various types of the driving portions such as the drum driving portion 91 and the belt driving portion 92 are connected, and these are controlled by signals from the control portion 3, respectively. In addition, to the control portion 3, the temperature sensor 71 and the humidity sensor 72 are connected. In addition, to the control portion 3, the voltage detecting sensor 75a and the current detecting sensor 75b of the primary transfer power source 75, the voltage detecting sensor 76a and the current detecting sensor 76b of the secondary transfer power source 76, the fixing temperature sensor 77, etc. are connected. A signal (information) indicating a detection result of each sensor is input to the control portion 3. In addition, to the control portion 3, a contact/separation mechanism 29, which will be described below, is connected, and the mechanism is controlled by a signal from the control portion 3. Incidentally, although illustration is omitted, in the present Embodiment, the contact/separation mechanism 29 is independently provided to each image forming unit 10.

In addition, to the control portion 3, an operating portion 70 is connected. The operating portion 70 includes an input portion, which is constituted by an operating button (key), etc., as an input means, and a display portion 70a, which is constituted by a liquid crystal panel (display), etc., as a display means. Incidentally, in the present Embodiment, the display portion 70a is configured as a touch panel, and also has a function as an input means. An operator such as a user and a service representative may cause, by operating the operating portion 70, the image forming apparatus 1 to execute a job (which will be described below). The control portion 3 operates, by receiving a signal from the operating portion 70, the various types of devices in the image forming apparatus 1. In addition, the image forming apparatus 1 may also execute the job according to a signal not from the operating portion 70 but from the external device such as a personal computer, for example.

Here, the image forming apparatus 1 executes the job (print job), which is a series of operations started by one start instruction, through which the image is formed and output on a single or a plurality of the recording material S. The job, generally, includes an image forming process, a pre rotation process, a sheet interval process in a case in which the images are formed on a plurality of the recording material S, and a post rotation process. The image forming process is a period in which, with respect to an image forming area, in which the image to be transferred onto the photosensitive drum 11 or the recording material S on the intermediary transfer belt 6 may be formed, the formation of the electrostatic image, the formation of the toner image, the primary transfer and the secondary transfer of the toner image are performed. During image formation (image forming period) refers to this period. In more detail, at positions at which respective processes of the formation of the electrostatic image, the formation of the toner image, the primary transfer and the secondary transfer of the toner image are performed, timings of during image formation are different from each other. The pre rotation process is a period in which a preparatory operation before the image forming process, from when the start instruction is input until the formation (exposure) of the image to be transferred to the recording material S is started, is performed. The sheet interval process (recording material interval process, image interval process) is a period which corresponds to an interval between the recording material S and the recording material S, upon continuously performing the image formation to a plurality of the recording material S (continuous print, continuous image formation). The post rotation process is a period in which an organizing operation (preparatory operation) after the image forming process is performed. During non-image formation (non-image forming period) is a period other than during image formation, and includes the pre rotation process, the sheet interval process, the post rotation process, which are described above, and further includes a pre-multi-rotation process, which is a preparatory operation when the image forming apparatus 1 is turned on or returns from a sleep state.

### 3. Problem in secondary transfer performance

Next, the problem in the secondary transfer performance will be further described. Incidentally, for the sake of convenience, large/small (high/low) of a voltage or a potential refers, unless otherwise particularly mentioned, to large/small (high/low) upon comparing the voltage or the potential in absolute values thereof. In addition, with respect to arrangement of the primary transfer portion N1, the photosensitive drum 11, the primary transfer roller 15, the potential regulating member 8, which will be described below, etc., an upstream and a downstream refers, unless otherwise particularly mentioned, to an upstream and a downstream with respect to the conveyance direction (process proceeding direction, movement direction) of the intermediary transfer belt 6.

As described above, for the toner on the intermediary transfer belt 6, in the downstream of the primary transfer portion N1, by being subjected to electric discharge between the intermediary transfer belt 6 and the photosensitive drum 11, a charge amount thereof tends to be increased. As the present inventor conduct diligent study, it is found that by the charge amount of the toner on the intermediary transfer belt 6 being increased, mirror force between the toner and the intermediary transfer belt 6 gets stronger, so that it becomes difficult to transfer the toner to the recording material S in the secondary transfer portion N2. For example, transferring the toner to an embossed paper, which has unevenness on a surface thereof, etc. uniformly is difficult since a gap is generated between the intermediary transfer belt 6 and the embossed paper in the secondary transfer portion N2 so that a relatively large secondary transfer electric field is required, etc. Therefore, as the charge amount of the toner on the intermediary transfer belt 6 is increased, the transfer of the toner to the embossed paper, which has unevenness on the surface thereof, etc. becomes further difficult. Incidentally, the embossed paper is a paper (fancy paper) on which a pattern by unevenness is applied to a surface of the paper by using a method such as embossing and stamping. In addition, also with respect to a recording material which has a relatively high electric resistance (high resistance paper) such as a synthetic paper and a resin film, which is mainly composed of a synthetic resin, similarly to the embossed paper, etc., as the charge amount of the toner on the intermediary transfer belt 6 is increased, the transfer of the toner thereto becomes further difficult.

In order to suppress the increase in the charge amount of the toner in the downstream of the primary transfer portion N1 as described above, it is effective to suppress the electric discharge in the downstream of the primary transfer portion N1. For that purpose, it is effective to make a potential difference between the photosensitive drum 11 and the intermediary transfer belt 6 after the primary transfer small. And in order to suppress the electric discharge in the downstream of the primary transfer portion N1, it is found that it is effective to dispose the potential regulating member, which is a conductive electrode member, in the downstream of the primary transfer portion N1 and on the inner peripheral surface side of the intermediary transfer belt 6, and to apply a bias having the same polarity as the charging polarity of the photosensitive drum 11 to the potential regulating member. Particularly, by disposing the potential regulating member 8 with contacting the inner peripheral surface of the intermediary transfer belt 6 and applying the voltage of the same polarity as the charging polarity of the photosensitive drum 11 to the potential regulating member 8, it becomes possible to suppress the electric discharge described above more effectively.

In addition, the electric discharge described above often occurs in an area from the primary transfer portion N1 to the downstream side by about 0.3 mm through 1.5 mm. To this, by applying the voltage of the same polarity as the charging polarity of the photosensitive drum 11 to the potential regulating member 8, it can be considered that, by an action of an electric field formed in a space between the photosensitive drum 11 and the potential regulating member 8, it becomes possible to suppress the electric discharge described above. And in the conveyance direction of the intermediary transfer belt 6, the effect to suppress the electric discharge described above becomes more significant in a case in which the potential regulating member 8 is brought into contact with the intermediary transfer belt 6 in a surface having a width than in a case in which the potential regulating member 8 is brought into contact with the intermediary transfer belt 6 at a point (in a line). In addition, by bringing the potential regulating member 8 into contact with the intermediary transfer belt 6 in a surface, it becomes possible to stabilize a contact state between the intermediary transfer belt 6 and the potential regulating member 8. It can be considered that this is because an electrostatic attraction force acts between the intermediary transfer belt 6 and the potential regulating member 8.

As such, it is more preferable that the potential regulating member 8 be brought into surface contact with the intermediary transfer belt 6. Here, having the surface contact (contact in a surface) means that cases of contacting only in a line shape in a direction crossing the conveyance direction of the intermediary transfer belt 6 in a range narrower than a contact width (about 5 mm through 50 mm), which will be described below in detail, are not included. Therefore, the surface contact (contact in a surface) includes, for example, not only a case in which substantially an entire area contacts continuously and closely in the contact width, which will be described below in detail, but also cases in which a large number of contact points are substantially uniformly distributed in the range described above as a non-woven fabric, etc.

### 4. Potential regulating member

Next, a configuration of the potential regulating member 8 in the present Embodiment will be described. As shown in FIG. 1, the image forming apparatus 1 in the present Embodiment includes the potential regulating members 8y, 8m, 8c and 8k, which are electrode members and disposed so as to contact the inner peripheral surface of the intermediary transfer belt 6 in the downstream of each of the primary transfer portions N1y, N1m, N1c and N1k, respectively. In the present Embodiment, the configurations of the potential regulating members 8y, 8m, 8c and 8k provided to each of the primary transfer portions N1y, N1m, N1c and N1k are substantially the same.

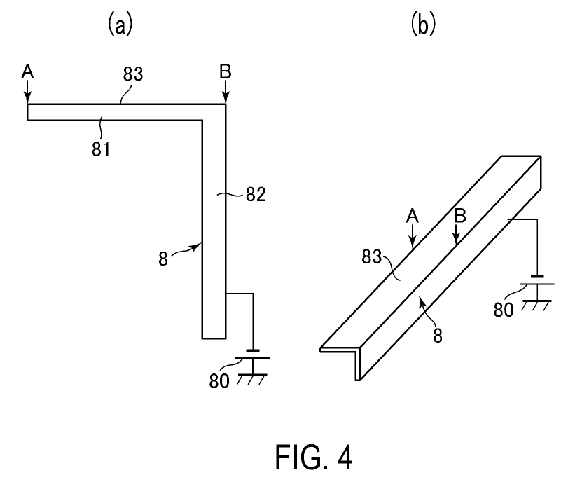

A shape of the potential regulating member 8 in the present Embodiment will be described. Part (a) of FIG. 4 is a cross-sectional view of the potential regulating member 8 in the present Embodiment (shows a cross-section approximately perpendicular to a rotational axis direction of the photosensitive drum 11). In addition, part (b) of FIG. 4 is a perspective view of the potential regulating member 8 in the present Embodiment.

In the present Embodiment, the potential regulating member 8 includes a first portion 81, which is planar and disposed along a widthwise direction of the intermediary transfer belt 6 (direction approximately perpendicular to the conveyance direction, direction approximately parallel to the rotational axis direction of the photosensitive drum 11). In addition, in the present Embodiment, the potential regulating member 8 includes a second portion 82, which has a flat surface shape and disposed along the widthwise direction of the intermediary transfer belt 6, and extends in a direction crossing (in the present Embodiment, approximately perpendicular to) a plane of the first portion 81. In the present Embodiment, a contact surface 83, which is a contact portion contacting the inner peripheral surface of the intermediary transfer belt 6, in the first portion 81 of the potential regulating member 8 is a flat surface. In other words, in the present Embodiment, the first portion 81 constituting the contact surface 83 of the potential regulating member 8 is a flat plate.

Here, in the cross-section approximately perpendicular to the rotational axis direction of the photosensitive drum 11, an end portion of the contact surface 83 on the upstream side is defined as “A (or an upstream end A)”, and an end portion of the contact surface 83 on the downstream side is defined as “B (or a downstream end B)”. In the present Embodiment, the upstream end A of the contact surface 83 corresponds to an end portion of the potential regulating member 8 on the upstream side, and the downstream end B of the contact surface 83 corresponds to an end portion of the potential regulating member 8 on the downstream side. As described above, in order to suppress the electric discharge between the intermediary transfer belt 6 and the photosensitive drum 11 more effectively by the action of the electric field formed in the space between the photosensitive drum 11 and the potential regulating member 8, it is preferable to bring the potential regulating member 8 into the surface contact with the intermediary transfer belt 6. From this viewpoint, it is preferable that a length of a line segment AB, in other words, the “contact width”, which is a length of the contact surface 83 in the conveyance direction of the intermediary transfer belt 6, be 5 mm or longer. The longer the length of the line segment AB, the larger the effect to suppress the electric discharge, however, if the length is too long, due to an effect of component precision, etc., it is expected that it becomes difficult to bring the potential regulating member 8 into contact with the intermediary transfer belt 6 stably.

It is often sufficient that the length of the line segment AB is 50 mm or shorter, and typically, is 30 mm or shorter. In other words, it is suitable that the length of the line segment AB be about 5 mm through 50 mm, and typically be about 5 mm through 30 mm. From another viewpoint, it can be said that it is often sufficient that the length of the line segment AB is, in the cross-section approximately perpendicular to the rotational axis direction of the photosensitive drum 11, a half or shorter of a distance between axes of the adjacent photosensitive drums 11. In the present Embodiment, the potential regulating member 8 of which the length of the line segment AB is 25 mm is used. Incidentally, in the present Embodiment, the distance between the axes of the photosensitive drums 11 in the cross-section approximately perpendicular to the rotational axis direction of the photosensitive drum 11 is about 100 mm.

To the potential regulating member 8, the potential regulating power source 80 as a potential regulating bias applying means (potential regulating bias applying portion) is connected. In the present Embodiment, the potential regulating power source 80 is connected to the second portion 82 of the potential regulating member 8. At least during primary transfer in the image forming operation, to the potential regulating member 8, by the potential regulating power source 80, a potential regulating bias (potential regulating voltage), which is direct current voltage of the same polarity as the charging polarity of the photosensitive drum 11, is applied. During primary transfer, more specifically, is a period during which a primary transfer bias is applied, and further specifically, is a period during which the image forming area (area to which the toner image may be transferred) on the intermediary transfer belt 6 is passing through the primary transfer portion N1. By this, it becomes possible to make the potential difference between the intermediary transfer belt 6 and the photosensitive drum 11 in the downstream of the primary transfer portion N1 small, and to suppress the electric discharge between the intermediary transfer belt 6 and the photosensitive drum 11 in the downstream of the primary transfer portion N1. In the present Embodiment, the potential regulating bias is direct current voltage of negative polarity. In addition, in the configuration in the present Embodiment, the potential regulating bias is suitably about -500 V through -5000 V, and more preferably, is about -1000 V through -3000 V. Incidentally, in the present Embodiment, the potential regulating bias is put under constant voltage control, however, the potential regulating bias may be put under constant current control. Incidentally, the constant current control is a control in which an output of a power source is adjusted so that a current supplied to a supplying target becomes approximately constant at a target current. In addition, the constant voltage control is a control in which an output of a power source is adjusted so that a voltage applied to an applying target becomes approximately constant at a target voltage.

The potential regulating member 8 is a member which is long in the widthwise direction of the intermediary transfer belt 6. It is preferable that a length in a longitudinal direction (direction along the widthwise direction of the intermediary transfer belt 6) of the contact surface 83 of the potential regulating member 8 be longer than a maximum image width in the widthwise direction of the intermediary transfer belt 6. Incidentally, the maximum image width is, in the widthwise direction of the intermediary transfer belt of the intermediary transfer belt 6, a length of the image forming area of a maximum image, which can be formed by the image forming apparatus 1. In the present Embodiment, the length in the longitudinal direction of the contact surface 83 of the potential regulating member 8 is longer than the maximum image width described above, and is longer than a width in which the primary transfer roller 15 contacts the intermediary transfer belt 6 in the widthwise direction of the intermediary transfer belt 6. In other words, in the present Embodiment, a range of the maximum image width described above, and a range of the width in which the primary transfer roller 15 contacts the intermediary transfer belt 6 in the widthwise direction of the intermediary transfer belt 6, both fall within a range of the length of the contact surface 83 of the potential regulating member 8 in the longitudinal direction thereof. By this, regardless of a length in the widthwise direction of the intermediary transfer belt 6 of the toner image transferred to the intermediary transfer belt 6, it becomes possible to obtain the effect to suppress the increase in the charge amount of the toner on the intermediary transfer belt 6 by suppressing the electric discharge. On the other hand, in the present Embodiment, the length of the potential regulating member 8 in the longitudinal direction is shorter than a width of the intermediary transfer belt 6. In other words, in the present Embodiment, a range of the length of the potential regulating member 8 in the longitudinal direction thereof falls within a range of the width of the intermediary transfer belt 6. By this, it becomes possible to suppress the electric discharge between the potential regulating member 8 and surrounding members, etc. of the intermediary transfer belt 6, which may occur in a case in which an end portion of the potential regulating member 8 in the longitudinal direction thereof is projected from an end portion of the intermediary transfer belt 6 in the widthwise direction thereof. As a result, it becomes possible to reduce a possibility that the effect to suppress the electric discharge between the intermediary transfer belt 6 and the photosensitive drum 11 becomes less.

The potential regulating member 8 may be constituted by one conductive stuff (material), for example, and for the material which constitutes the potential regulating member 8, metal, resin, cloth, non-woven fabric, etc. can be used. In the present Embodiment, the potential regulating member 8 is constituted by substantially only conductive metal such as SUS (stainless steel). In more detail, in the present Embodiment, the potential regulating member 8 is constituted by applying bending processing to a metal plate material (sheet metal) such as SUS to form the first portion 81 and the second portion 82. By applying the bending processing in this manner, it is possible to increase strength of the potential regulating member 8. In the present Embodiment, in the potential regulating member 8, both of the first portion 81 and the second portion 82 are not substantially deformed in a use state of the image forming apparatus 1. However, the present invention is not limited to such a configuration, but the potential regulating member 8 may be constituted by two or more of the materials.

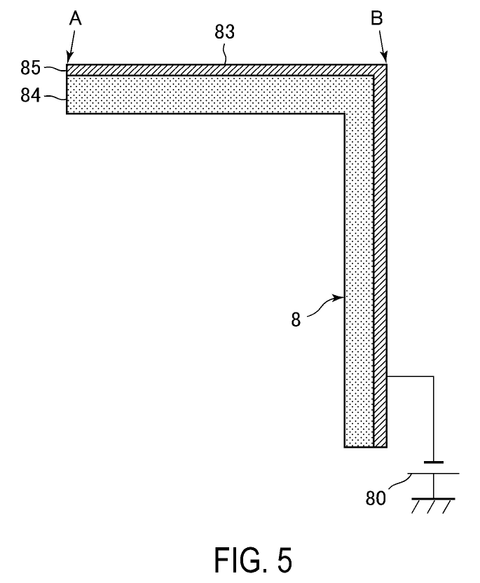

FIG. 5 is a cross-sectional view of another example of the potential regulating member 8 (shows a cross-section approximately perpendicular to the rotational axis direction of the photosensitive drum 11). For example, as shown in FIG. 5, it may be configured to include a base portion 84, which has the same shape as that of the potential regulating member 8 shown in FIG. 4, and a surface layer 85 provided on a surface of the base portion 84. The surface layer 85 constituting a contact surface 83, which contacts the intermediary transfer belt 6, and a connecting portion to the potential regulating power source 80 is constituted by a conductive material, for example, metal or conductive resin. The base portion 84 may be constituted by conductive material, but may also be constituted by a non-conductive material, for example, non-conductive resin, etc. The base portion 84 and the surface layer 85 may be fixed by arbitrary fixing means such as adhesion with an adhesive and welding.

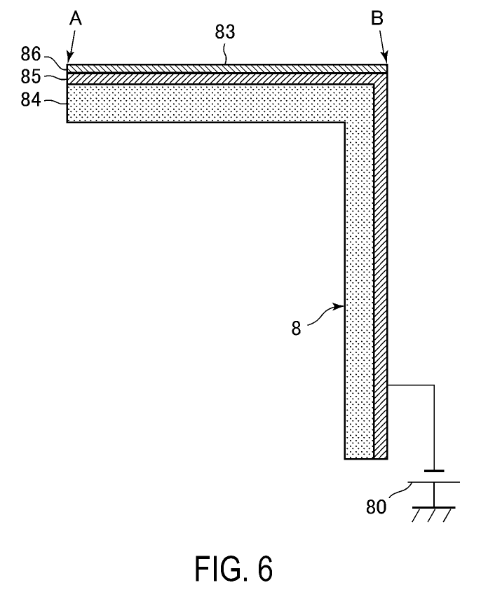

In addition, FIG. 6 is a cross-sectional view of still another example of the potential regulating member 8 (shows a cross-section approximately perpendicular to the rotational axis direction of the photosensitive drum 11.). For example, as shown in FIG. 6, a contact surface 83 of the potential regulating member 8, which contacts the intermediary transfer belt 6, may be constituted by a conductive non-woven fabric 86. Incidentally, in FIG. 6, the conductive non-woven fabric 86 is provided on the contact surface 83 in the potential regulating member 8 having the configuration shown in FIG. 5, however, the conductive non-woven fabric 86 may be provided on the contact surface 83 in the potential regulating member 8 having the configuration shown in FIG. 4. The conductive non-woven fabric 86 may be fixed by arbitrary fixing means such as adhesion by a conductive adhesive. In addition, instead of the non-woven fabric 86, for example, the following may be used. That is, a felt or a pile fabric (cut pile fabric (velvet, brush) or a loop pile fabric (towel fabric)) constituted by using conductive fibers, a sponge (elastic foam member) constituted by using a conductive rubber material, or the like. As such, by constituting the contact surface 83 of the potential regulating member 8, which contacts the intermediary transfer belt 6, with the material which has flexibility or elasticity, it becomes possible to reduce a possibility that a scratch is generated on the inner peripheral surface of the intermediary transfer belt 6 due to rubbing between the inner peripheral surface of the intermediary transfer belt 6 and the potential regulating member 8.

### 5. Disposition of potential regulating member

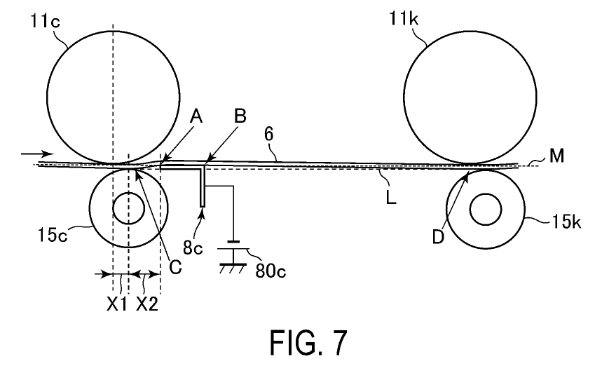

Next, disposition of the potential regulating member 8 in the present Embodiment will be described. FIG. 7 is a cross-sectional view for describing disposition of the potential regulating member 8 provided between two of the primary transfer portions N1 which are adjacent to each other in the conveyance direction of the intermediary transfer belt 6 (shows a cross-section approximately perpendicular to the rotational axis direction of the photosensitive drum 11.). In FIG. 7, as an example, the potential regulating member 8c provided between the respective primary transfer portions N1c and N1k of cyan and black (in other words, provided corresponding to the primary transfer portion N1c of cyan) is shown.

The outer diameter of the photosensitive drum 11 is, for example, 30 mm, the outer diameter of the primary transfer roller 15 is, for example, 18 mm, and a thickness of the intermediary transfer belt 6 is, for example, 0.350 mm. In the present Embodiment, the primary transfer roller 15 is disposed with being offset to a downstream side with respect to the photosensitive drum 11. In the present Embodiment, an offset amount X1 is 3 mm. Incidentally, the offset amount X1 is a distance, in the cross-section approximately perpendicular to the rotational axis direction of the photosensitive drum 11, in a direction along a common tangent line on a side in which the plurality of the photosensitive drums 11 contact the intermediary transfer belt 6, between a rotational center of the photosensitive drum 11 and a rotational center of the primary transfer roller 15.

Here, in order to describe the disposition of the potential regulating member 8, a case in which the potential regulating member 8 is removed is assumed. In the cross-section approximately perpendicular to the rotational axis direction of the photosensitive drum 11, in a case in which the potential regulating member 8 is absent, a straight line through which a stretched surface on the inner peripheral surface side of the intermediary transfer belt 6 in the downstream of the primary transfer portion N1 passes, is defined as a straight line L. Incidentally, in more detail, this straight line L corresponds to the stretched surface described above in a state in which substantially only the potential regulating member 8 is removed from the configuration of the image forming apparatus 1 in a state of the image forming operation (state in which the intermediary transfer belt 6 is set in a stretched form capable of the image formation) (however, the photosensitive drum 11 and the intermediary transfer belt 6 are stopped.). In addition, on the straight line L, a location at which the inner peripheral surface of the intermediary transfer belt 6 is separated from the stretching member, which is immediately near on the upstream side of the potential regulating member 8, is defined as “C (or an upstream stretching portion C)”, and a location at which separated from the stretching member, which is immediately near on the downstream side of the potential regulating member 8 is defined as “D (or a downstream stretching portion D)”. Incidentally, in FIG. 7, the straight line L is schematically shown substantially horizontally, however, in a case in which a surface of the primary transfer roller 15 is lifted to the photosensitive drum 11 side by the elastic layer of the primary transfer roller 15 being deformed, etc., the straight line L may be inclined so as to go downward in FIG. 7 as it goes to the downstream side.

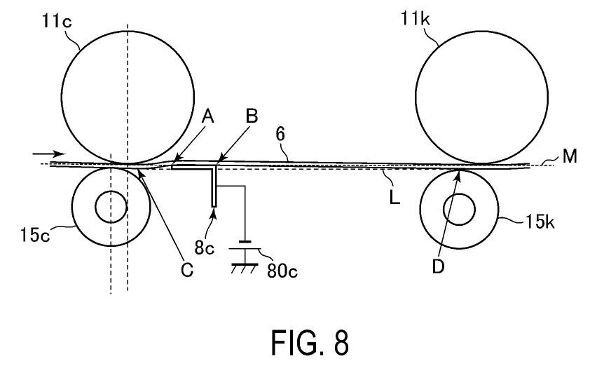

As shown in FIG. 7, in the present Embodiment, the stretching member, which is immediately near on the upstream side of the potential regulating member 8, is the primary transfer roller 15, and a position on the inner peripheral surface of the intermediary transfer belt 6 at the location, at which the intermediary transfer belt 6 is separated from the primary transfer roller 15, is the upstream stretching portion C. However, the stretching member, which is immediately near on the upstream side of the potential regulating member 8, is not limited to the primary transfer roller 15. For example, as shown in FIG. 8, in a case in which the primary transfer roller 15 is disposed with being offset to the upstream side with respect to the photosensitive drum 11, a position on the inner peripheral surface of the intermediary transfer belt 6 at a location corresponding to a location, at which the intermediary transfer belt 6 is separated from the photosensitive drum 11, is the upstream stretching portion C.

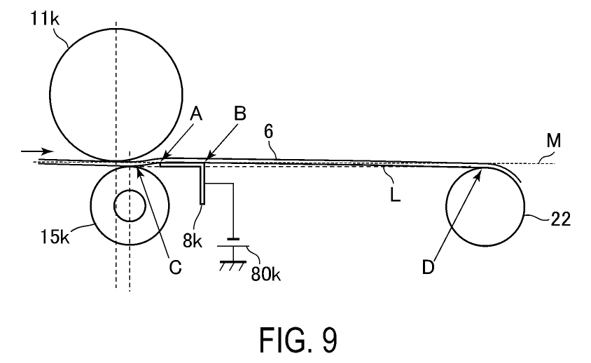

In addition, as shown in FIG. 7, in the present Embodiment, the stretching members, which are immediately near on the downstream side of the potential regulating member 8, with respect to the primary transfer portions N1y, N1m and N1c of yellow, magenta and cyan, are the photosensitive drums 11m, 11c and 11k disposed adjacently on the respective downstream sides thereof. And the positions on the inner peripheral surface of the intermediary transfer belt 6 at locations corresponding to locations, at which the intermediary transfer belt 6 is separated from the photosensitive drums 11m, 11c and 11k, respectively, are the downstream stretching portions D. However, the stretching member, which is immediately near on the downstream side of the potential regulating member 8, is not limited to the photosensitive drum 11. For example, as shown in FIG. 8, in a case in which the primary transfer roller 15 is disposed with being offset to the upstream side with respect to the photosensitive drum 11, a position on the inner peripheral surface of the intermediary transfer belt 6 at a location, at which the intermediary transfer belt 6 is separated from the primary transfer roller 15, is the downstream stretching portion D. In addition, as shown in FIG. 9, in the present Embodiment, with respect to the downstreammost primary transfer portion N1k of black, the stretching member, which is immediately near on the downstream side, is the stretching roller (in the present Embodiment, the tension roller) 22. And, a position on the inner peripheral surface of the intermediary transfer belt 6 at a location at which the intermediary transfer belt 6 is separated from the stretching roller 22, is the downstream stretching portion D.

Furthermore, with respect to any of the primary transfer portions N1, in a case in which as the stretching member immediately near on the downstream side of the potential regulating member 8, another stretching roller regulating a posture of the intermediary transfer belt 6 during image forming operation is present, the straight line L and the downstream stretching portion D are defined with that stretching roller as a reference. In addition, instead of the stretching roller, also in a case in which a scraper or a brush is brought into contact with the inner peripheral surface of the intermediary transfer belt 6 for a purpose of cleaning the inner peripheral surface of the intermediary transfer belt 6, etc., if the posture of the intermediary transfer belt 6 is regulated by the scraper or the brush during image forming operation, it may be regarded as the stretching member immediately near in the downstream.

As shown in FIG. 7, the potential regulating member 8 is disposed, so as not to contact the primary transfer roller 15 and not to be in contact with the photosensitive drum 11 via the intermediary transfer belt 6, adjacently in the downstream of the primary transfer portion N1. In this case, the closer the upstream end A is to the primary transfer portion N1, the more significant the effect to suppress the electric discharge between the intermediary transfer belt 6 and the photosensitive drum 11 becomes. In the present Embodiment (FIG. 7), the potential regulating member 8 is disposed at a position in the downstream of the primary transfer portion N1 so that a distance X2 from the primary transfer roller 15 to the upstream end A becomes about 8 mm. Here, the distance X2 is a distance, in the cross-section approximately perpendicular to the rotational axis direction of the photosensitive drum 11, in the direction along the common tangent line on the side in which the plurality of photosensitive drums 11 contact the intermediary transfer belt 6, between the rotational center of the primary transfer roller 15 and the upstream end A. It is not limited to this, however, the distance X2 may suitably be about 1 mm through 20 mm, and typically be about 1 mm through 10 mm.

And in the present Embodiment, at least during primary transfer in the image forming operation, the potential regulating member 8 is pressed, by an urging means, (not shown) against the inner peripheral surface of the intermediary transfer belt 6. In this case, a contact portion, at which the potential regulating member 8 contacts the inner peripheral surface of the intermediary transfer belt 6, is configured to enter the photosensitive drum 11 side over the straight line L. By this, even in a case in which waving or vibration occurs in the intermediary transfer belt 6 during image forming operation (during running of the intermediary transfer belt 6), it becomes possible to cause the potential regulating member 8 to contact the intermediary transfer belt 6 more stably. In the present Embodiment, pressing force of a pressing spring 87 is set (adjusted) so as to cause the upstream end A and the downstream end B of the contact surface 83 of the potential regulating member 8, which are the contact portions contacting the inner peripheral surface of the intermediary transfer belt 6, to enter the photosensitive drum 11 side by about 0.5 mm with respect to the straight line L. In this manner, by causing the contact surface 83 of the potential regulating member 8 to enter the photosensitive drum 11 side with respect to the straight line L, even in the case in which the waving or the vibration occurs in the intermediary transfer belt 6 during image forming operation (during running of the intermediary transfer belt 6), it becomes possible to bring the potential regulating member 8 into the surface contact with the intermediary transfer belt 6 more stably. It is not limited to this, however, an entering amount of the contact surface 83 of the potential regulating member 8 with respect to the straight line L may suitably be about 0.3 mm through 5 mm, and typically be about 0.5 mm through 3 mm. When this entering amount is too small, there is a possibility that it becomes difficult to cause the potential regulating member 8 to contact the intermediary transfer belt 6 stably, and when the entering amount is too large, there is a possibility that it becomes difficult to realize stable conveyance of the intermediary transfer belt 6. The urging means for pressing the potential regulating member 8 against the inner peripheral surface of the intermediary transfer belt 6 will be described below.

Here, in the cross-section approximately perpendicular to the rotational axis direction of the photosensitive drum 11, a straight line which passes through the upstream end A and the downstream end B of the contact surface 83 is defined as a straight line M. In this case, it is preferable to configure so that the straight line M do not to cross a line segment CD in the straight line L. By this, in the case in which the contact surface 83 of the potential regulating member 8 is planar, it becomes possible to bring the intermediary transfer belt 6 and the potential regulating member 8 into the surface contact with each other more reliably. In a case in which the straight line M crosses the line segment CD in the straight line L, there is a possibility that it becomes possible for only either the end portion of the potential regulating member 8 on the upstream end A side or the end portion of the potential regulating member 8 on the downstream end B side to contact the inner peripheral surface of the intermediary transfer belt 6. In this case, there is a possibility that it becomes difficult to enhance the electric discharge suppressing effect described above by the surface contact.

In addition, in FIG. 7, the potential regulating member 8 is disposed so that the straight line M and the straight line L are approximately parallel to each other, however, as long as it is within a range in which the straight line M does not cross the line segment CD in the straight line L, the potential regulating member 8 may be disposed so as the straight line M to be inclined with respect to the straight line L. For example, by inclining the straight line M with respect to the straight line L so that the upstream end A side becomes closer to the straight line L than the downstream end B side, it becomes possible to make a curvature, which is generated in the intermediary transfer belt 6 due to wrapping of the intermediary transfer belt 6 in a vicinity of the upstream end A, small. Therefore, it is advantageous for reduction of the possibility that the scratch is generated on the inner peripheral surface of the intermediary transfer belt 6 due to the rubbing against the potential regulating member 8.

Incidentally, the contact portion of the potential regulating member 8, which contacts the inner peripheral surface of the intermediary transfer belt 6, is not limited to being planar. For example, it may be configured that the potential regulating member 8 is constituted by a bent plate, of which a cross-section approximately perpendicular to the rotational axis direction of the photosensitive drum 11 is curved in a curved line shape projected on the photosensitive drum 11 side, and a contact portion of the potential regulating member 8, which contacts the inner peripheral surface of the intermediary transfer belt 6, has a curved surface projected on the photosensitive drum 11 side. In this manner, by configuring the contact portion (contact surface) of the potential regulating member 8, which contacts the inner peripheral surface of the intermediary transfer belt 6, as a curved surface shape, it becomes possible to reduce stress upon the contact portion (contact surface) being rubbed against the intermediary transfer belt 6. By using the potential regulating member 8 having a roller shape, the contact portion of the potential regulating member 8, which contacts the inner peripheral surface of the intermediary transfer belt 6, may be configured as a curved surface.

### 6. Supporting configuration for the primary transfer roller and the potential regulating member

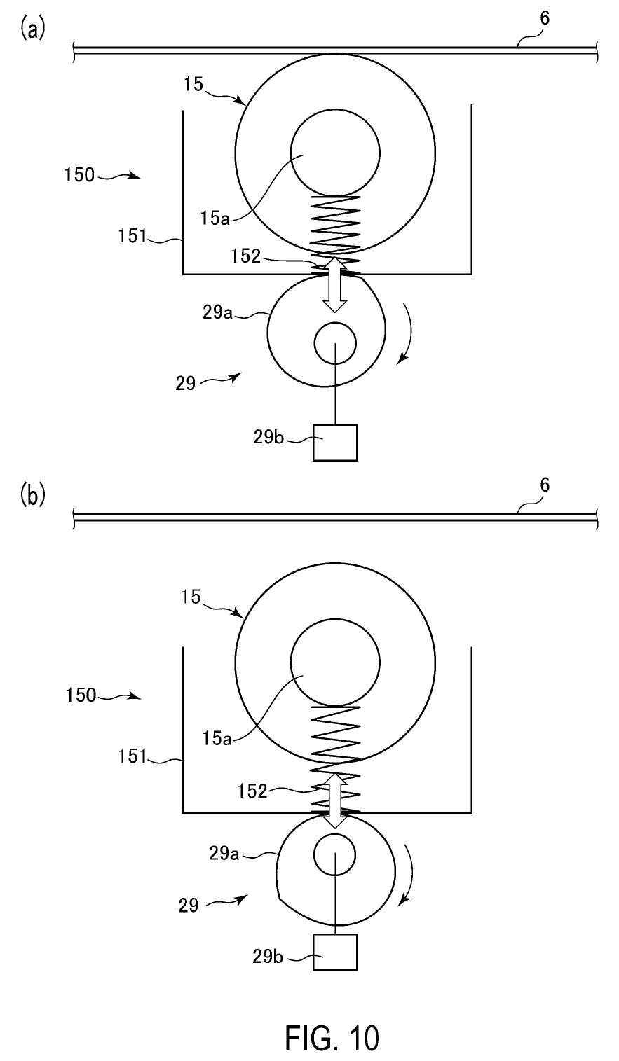

Next, a supporting configuration for the primary transfer roller 15 in the present Embodiment will be described. FIG. 10, part (a) and part (b), includes schematic cross-sectional views for describing the supporting configuration for the primary transfer roller 15 in the present Embodiment (shows a cross-section approximately perpendicular to a rotational axis direction of the primary transfer roller 15.). Part (a) of FIG. 10 illustrates a state in which the primary transfer roller 15 contacts the inner peripheral surface of the intermediary transfer belt 6, and part (b) of FIG. 10 illustrates a state in which the primary transfer roller 15 is separated from the inner peripheral surface of the intermediary transfer belt 6. Incidentally, in the present Embodiment, the supporting configurations for respective primary transfer rollers 15y, 15m, 15c and 15k are substantially the same.

The image forming apparatus 1 includes a primary transfer holder 151 as a primary transfer holding member which holds the primary transfer roller 15. The primary transfer holder 151 supports rotation shaft portions 15a at both end portions in the rotational axis direction of the primary transfer roller 15 movably (in a slidably movable manner) in a direction of coming closer to and going away from the inner peripheral surface of the intermediary transfer belt 6 and rotatably. Between the rotation shaft portions 15a at both end portions of the primary transfer roller 15 and the primary transfer holder 151, a primary transfer spring 152 constituted by a compression coil spring, which is an urging member, as an urging means is disposed. The primary transfer roller 15 is urged by the primary transfer spring 152 in a direction toward the intermediary transfer belt 6. Incidentally, the rotation shaft portions 15a at both end portions of the primary transfer roller 15 may be supported by the primary transfer holder 151 via bearings, and may be urged by the primary transfer spring 152 via the bearing. A primary transfer unit 150 is configured to include the primary transfer roller 15, the primary transfer holder 151 and the primary transfer spring 152.

In addition, the image forming apparatus 1 includes the contact/separation mechanism 29 as a contacting and separating means, which causes the primary transfer roller 15 to contact and be separated from the inner peripheral surface of the intermediary transfer belt 6. And in the present Embodiment, the primary transfer roller 15 is, in a standby state of the image forming apparatus 1, so as not to contact the intermediary transfer belt 6, retracted from the intermediary transfer belt 6 with whole of the primary transfer unit 150 by the contact/separation mechanism 29. In other words, the primary transfer roller 15 is moved, by the contact/separation mechanism 29, to a contacting position (third position) at which contacting the intermediary transfer belt 6, and a retracted position (fourth position) at which not contacting the intermediary transfer belt 6. Here, the standby state of the image forming apparatus 1 is a state, after the image forming apparatus 1 is turned on and a predetermined operation is performed, of waiting for an input of a job to the image forming apparatus 1. In the standby state, the operations of movable members involved in the image formation such as the photosensitive drum 11 and the intermediary transfer belt 6 are stopped. Incidentally, in the present Embodiment, also in a power source off state of the image forming apparatus 1 and in a sleep state (state in which supply of electric power except to a part of elements such as the control portion 3 is stopped in a power source on state), the primary transfer roller 15 is separated from the inner peripheral surface of the intermediary transfer belt 6. In addition, in a case in which a monochrome mode such as a single color mode of black is provided, it may be configured that the primary transfer rollers 15 for colors for which the image formations are not performed are separated from the inner peripheral surface of the intermediary transfer belt 6.

For example, the contact/separation mechanism 29 includes a moving member 29a as a moving means, which moves the primary transfer holder 151, and a contact/separation driving portion 29b, which drives the moving member 29a. The moving member 29a is constituted by, for example, an eccentric rotatable member such as an eccentric gear and cam. The contact/separation driving portion 29b is configured to include a motor as a driving source, a drive transmitting member which transmits driving force from the motor to the moving member 29a, etc. Incidentally, at least a part of the elements of the contact/separation mechanism 29 (such as the motor) may be commonized among the plurality of the primary transfer unit 150.

The primary transfer holder 151 is supported by a frame (not shown) of the intermediary transfer unit 20, etc. movably (in slidably movable manner) in the direction of coming closer to and going away from the inner peripheral surface of the intermediary transfer belt 6. The contact/separation mechanism 29 brings, by causing the moving member 29a to be rotated and causing the primary transfer holder 151 to be moved in the direction of coming closer to the inner peripheral surface of the intermediary transfer belt 6, the primary transfer roller 15 into contact with the intermediary transfer belt 6 (part (a) of FIG. 10). In a state in which the primary transfer holder 151 is disposed at a near position with a predetermined distance from the inner peripheral surface of the intermediary transfer belt 6 by the contact/separation mechanism 29, the primary transfer roller 15 is pressed by the primary transfer spring 152 toward the intermediary transfer belt 6 with predetermined pressing force. As a result, the intermediary transfer belt 6 is pressed toward the photosensitive drum 11. In addition, the contact/separation mechanism 29 allows, by causing the moving member 29a to be rotated, the primary transfer holder 151 to be moved in the direction of going away from the inner peripheral surface of the intermediary transfer belt 6 by own weight of the primary transfer unit 150, for example. In a state in which the primary transfer holder 151 is disposed at a separated position with a predetermined distance from the inner peripheral surface of the intermediary transfer belt 6 by the contact/separation mechanism 29, the primary transfer roller 15 is separated from the inner peripheral surface of the intermediary transfer belt 6 (part (b) of FIG. 10).

Incidentally, a retracting method and a pressing method of the primary transfer roller 15 with respect to the intermediary transfer belt 6 are not limited to the methods in the present Embodiment. For example, it may be a configuration such that the primary transfer roller 15 is pressed by a spring, etc. and the pressing is released by a releasing member.

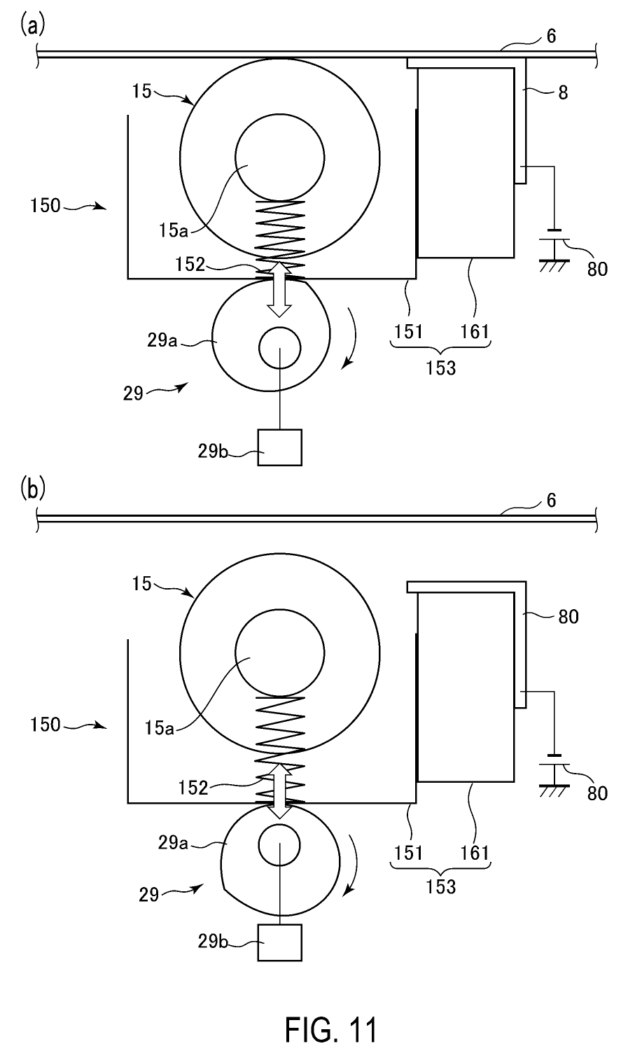

Next, a supporting configuration for the potential regulating member 8 in the present Embodiment will be described. FIG. 11, part (a) and part (b), includes schematic cross-sectional views for describing the supporting configuration for the primary transfer roller 15 in the present Embodiment (shows cross-sections approximately perpendicular to the rotational axis direction of the primary transfer roller 15.). Part (a) of FIG. 11 illustrates a state in which the potential regulating member 8 contacts the inner peripheral surface of the intermediary transfer belt 6, and part (b) of FIG. 11 illustrates a state in which the potential regulating member 8 is separated from the inner peripheral surface of the intermediary transfer belt 6. Incidentally, in the present Embodiment, the support configurations for the respective potential regulating members 8y, 8m, 8c and 8k are substantially the same.

The image forming apparatus 1 includes a potential regulating holder 161, which holds the potential regulating member 8, as a potential regulating holding member. It is desirable that a distance between the primary transfer roller 15 and the potential regulating member 8 be constant. Therefore, in the present Embodiment, the primary transfer holder 151, which holds the primary transfer roller 15, and the potential regulating holder 161, which holds the potential regulating member 8, are integrated. That is, in the present Embodiment, the image forming apparatus 1 includes a unit holder 153 in which the primary transfer holder 151 as a first holding portion and the potential regulating holder 161 as a second holding portion are integrated. In addition, in the present Embodiment, it can be said that the primary transfer unit 150 is configured to include the primary transfer roller 15, the primary transfer spring 152, the potential regulating member 8 and the unit holder 153 (the primary transfer holder 151 and the potential regulating holder 161). By this, it becomes possible to improve positional accuracy of the potential regulating member 8. In the potential regulating member 8, the first portion 81 is supported by an upper surface of the potential regulating holder 161. The potential regulating member 8 is fixed to the potential regulating holder 161 by an arbitrary fixing means such as adhesion, welding, fastening and snap-fitting (elastic engagement).

In addition, in the present Embodiment, it is configured that the potential regulating member 8 is capable of being brought into contact with and separated from the inner peripheral surface of the intermediary transfer belt 6 by the contact/separation mechanism 29. In other words, in the present Embodiment, the contact/separation mechanism 29 functions as a contact/separation means, which causes the primary transfer roller 15 to contact and be separated from the inner peripheral surface of the intermediary transfer belt 6, and also functions as a contact/separation means, which causes the potential regulating member 8 to contact and be separated from the inner peripheral surface of the intermediary transfer belt 6. And, in the present Embodiment, the potential regulating member 8 is retracted, in the standby state of the image forming apparatus 1, so as not to contact the intermediary transfer belt 6, from the intermediary transfer belt 6 with the whole of the primary transfer unit 150 by the contact/separation mechanism 29. In other words, the potential regulating member 8 is moved, by the contact/separation mechanism 29, to a contacting position (first position) at which contacting the intermediary transfer belt 6, and a retracted position (second position) at which not contacting the intermediary transfer belt 6. Incidentally, in the present Embodiment, also in the power source off state of the image forming apparatus 1 and the sleep state, the potential regulating member 8 is separated from the inner peripheral surface of the intermediary transfer belt 6. In addition, in the case in which the monochrome mode such as the single color mode of black is provided, it may be configured that the potential regulating members 8 for colors for which image formations are not performed are separated from the inner peripheral surface of the intermediary transfer belt 6.

The potential regulating holder 161 is moved, by the primary transfer holder 151 being moved by the contact/separation mechanism 29, in the direction of coming closer to and going away from the inner peripheral surface of the intermediary transfer belt 6 as the unit holder 153 integrally with the primary transfer holder 151. The contact/separation mechanism 29 causes, by causing the moving member 29a to be rotated and causing the potential regulating holder 161 (unit holder 153) to be moved in the direction of coming closer to the inner peripheral surface of the intermediary transfer belt 6, the potential regulating member 8 to contact the intermediary transfer belt 6 (part (a) of FIG. 11). In a state in which the potential regulating holder 161 is disposed at a near position with a predetermined distance from the inner peripheral surface of the intermediary transfer belt 6 by the contact/separation mechanism 29, the potential regulating member 8 contacts (has the surface contact with) the inner peripheral surface of the intermediary transfer belt 6 with the predetermined entering amount as described above. In addition, the contact/separation mechanism 29 allows, by causing the moving member 29a to be rotated, the potential regulating holder 161 (unit holder 153) to be moved in the direction of going away from the inner peripheral surface of the intermediary transfer belt 6 by own weight of the primary transfer unit 150, for example. In a state in which the potential regulating holder 161 is disposed at a separated position with a predetermined distance from the inner peripheral surface of the intermediary transfer belt 6 by the contact/separation mechanism 29, the potential regulating member 8 is separated from the inner peripheral surface of the intermediary transfer belt 6 (part (b) of FIG. 11).

Incidentally, a retracting method and a pressing method of the potential regulating member 8 with respect to the intermediary transfer belt 6 are not limited to the methods in the present Embodiment. For example, it is not limited to integrating a member holding the primary transfer roller 15 and the potential regulating member 8 as in the present Embodiment, but these may be configured as separate members. It is sufficient that a positional relationship between the primary transfer roller 15 and the potential regulating member 8 can be properly maintained. For example, the potential regulating member 8 may be supported by the potential regulating holder 161, which is a separate member from the primary transfer holder 151. And, for example, it may be configured to cause the potential regulating holder 161 to be moved by a contact/separation mechanism, which is separate from the contact/separation mechanism for the primary transfer roller 15. For the separate contact/separation mechanism, one having the same configuration as that of the contact/separation mechanism 29 described above may be used, for example.

In addition, the potential regulating member 8 may be configured so as, for example, at both end portions in the longitudinal direction thereof, to be pressed toward the inner peripheral surface of the intermediary transfer belt 6 by a pressing spring disposed between the potential regulating member 8 and the potential regulating holder 161. The pressing spring may be constituted by a compression coil spring which is an urging member as an urging means.

### 7. Inner surface cleaning member

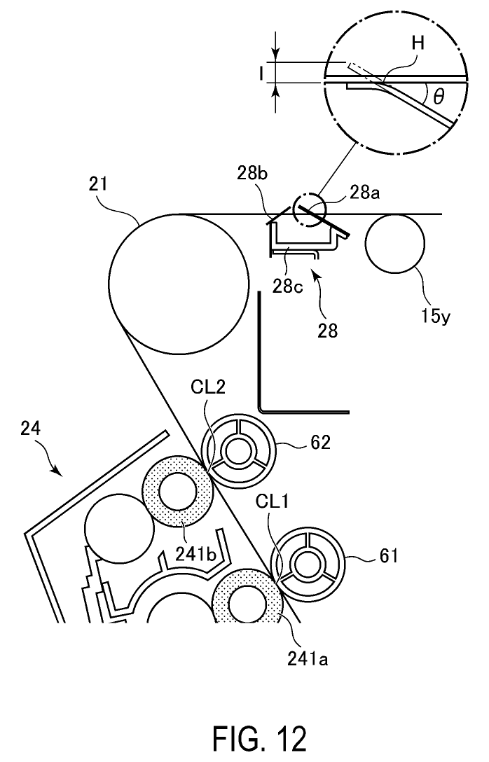

Next, an inner surface cleaning member for cleaning the inner peripheral surface (inner surface) of the intermediary transfer belt 6 will be described. FIG. 12 through FIG. 14 are cross-sectional outline views of a vicinity of the inner surface cleaning member for describing examples of configurations and arrangements of the inner surface cleaning member, respectively (shows a cross-section approximately perpendicular to a rotational axis direction of the stretching roller for the intermediary transfer belt 6.).

First, with reference to FIG. 12, the configuration of the inner surface cleaning member will be described. The image forming apparatus 1 includes, for a purpose of cleaning the inner surface of the intermediary transfer belt 6, a scraper unit 28 disposed on the inner surface side of the intermediary transfer belt 6. The scraper unit 28 includes a scraper 28a as an inner surface cleaning member, which cleans the inner surface of the intermediary transfer belt 6, a scooping sheet 28b as a scattering preventing member, and a supporting member 28c for supporting these.

The scraper 28a is constituted, generally, by a member having a sheet shape, a film shape, or a plate shape. For the scraper 28a, a sheet (film) made of resin such as PC (polycarbonate), polyethylene, polyester and PET (polyethylene terephthalate), or a thin plate made of metal such as SUS and brass can be suitably used. In the present Embodiment, the scraper 28a is constituted by a member having a sheet shape of approximately rectangular in a plan view, which has predetermined lengths in a longitudinal direction, which is disposed along the widthwise direction of the intermediary transfer belt 6, and in a widthwise direction, which is approximately perpendicular to the longitudinal direction, respectively, and has a predetermined thickness. The scraper 28a is brought into contact with the inner surface of the intermediary transfer belt 6, so that a free end portion, which is one end portion in the widthwise direction thereof, faces the upstream side in the movement direction of the intermediary transfer belt 6, in a counter direction with respect to the movement direction of the intermediary transfer belt 6. In addition, the scraper 28a is supported, by a fixed end portion, which is the other end portion in the widthwise direction thereof, being fixed to the supporting member 28c, by the supporting member 28c. The length in the longitudinal direction of the scraper 28a is configured to be approximately the same as the width of the intermediary transfer belt 6. The scraper 28a rubs, along with the movement (rotation) of the intermediary transfer belt 6, the inner surface of the intermediary transfer belt 6, and scrapes off adhering material (foreign matter) adhered to the inner surface of the intermediary transfer belt 6. A contact portion between the scraper 28a and the intermediary transfer belt 6 is an inner surface cleaning portion H. The adhering material removed from the inner surface of the intermediary transfer belt 6 by the scraper 28a is accumulated on the supporting member 28c, for example. The adhering material adhered to the inner surface of the intermediary transfer belt 6 will be described below.

In the scraper 28a, so that the free end portion in the widthwise direction faces the upstream side in the movement direction of the intermediary transfer belt 6, an edge of the free end portion is in contact with the inner surface of the intermediary transfer belt 6. Therefore, in order to suppress that the adhering material scraped off by the scraper 28a scatters (diffuses) inside the apparatus, the scooping sheet 28b is provided. The scooping sheet 28b is constituted by a member having a sheet shape or a film shape. For the scooping sheet 28b, a sheet or a film made of resin such as urethane, PET and polyester can be suitably used.

In the present Embodiment, a urethane sheet is used for the scooping sheet 28b. In the present Embodiment, the scooping sheet 28b is constituted, similarly to the scraper 28a, by a member having a sheet shape of approximately rectangular in a plan view. The scooping sheet 28b is provided on the upstream side with respect to the scraper 28a in the movement direction of the intermediary transfer belt 6 so as to face the scraper 28a. In the scooping sheet 28b, a free end portion, which is one end portion in a widthwise direction thereof, is brought into contact with the inner surface of the intermediary transfer belt 6. In addition, the scraper 28a is supported, by a fixed end portion, which is the other end portion in the widthwise direction thereof, being fixed to the supporting member 28c, by the supporting member 28c. A length in a longitudinal direction of the scooping sheet 28b is configured to be approximately the same as the width of the intermediary transfer belt 6.

The scraper 28a, the scooping sheet 28b and the supporting member 28c are integrally unitized as the scraper unit 28. And, in the present Embodiment, the scraper unit 28 is configured so as to be capable of being pulled out from a front (front side of the paper of FIG. 1 and FIG. 12) of the intermediary transfer unit 20. By this, it becomes possible to clean periodically, for example, the adhering material scraped off from the inner surface of the intermediary transfer belt 6 by the scraper 28a.

It is preferable that the scraper 28a be installed, as shown in FIG. 12, in the movement direction of the intermediary transfer belt 6, between a roller, which contacts the inner surface of the intermediary transfer belt 6 at immediately near on the upstream side of the upstreammost primary transfer portion N1 (primary transfer roller 15), and the upstreammost primary transfer portion N1 (primary transfer roller 15). Incidentally, the installation position of the scraper 28a as shown in FIG. 12 is also referred to simply as “a position immediately near on the upstream side of an upstreammost potential regulating member 8”. The installation position of the scraper 28a is represented by the inner surface cleaning portion H. By this, upon starting or stopping the rotation of the intermediary transfer belt 6, which will be described below, it becomes possible to make a time, for which the intermediary transfer belt 6 is rotated in the state in which the potential regulating member 8 is retracted from the intermediary transfer belt 6, shorter. In other words, it becomes possible to make a rotation amount (moving amount) of the intermediary transfer belt 6 small.

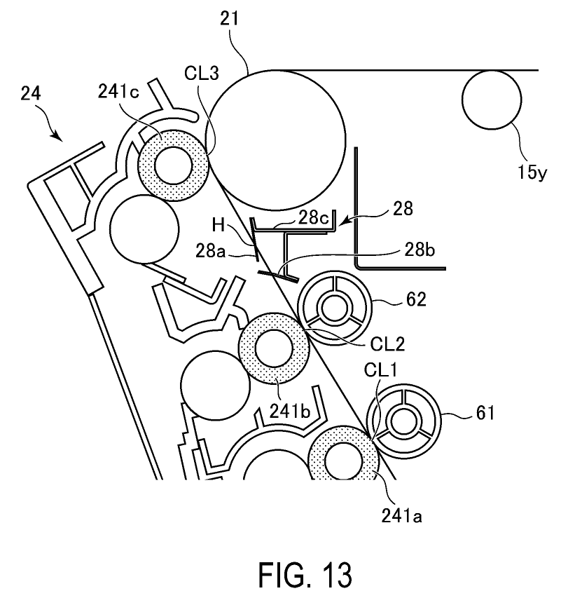

In addition, due to circumstance of arrangement, for example, it may be assumed of a case as well in which the scraper 28a may not be disposed at the position immediately near on the upstream side of the upstreammost potential regulating member 8. Even in this case, as shown in FIG. 13, it is desirable that the scraper 28a be disposed at a position as close as possible on the upstream side of the upstreammost potential regulating member 8. For example, it can be said that it is desirable that the scraper 28a be installed, in the movement direction of the intermediary transfer belt 6, on the downstream side of the secondary transfer portion N2 and on the upstream side of the upstreammost primary transfer portion N1 (primary transfer roller 15). In addition, from another viewpoint, there is a case in which it is desirable that the scraper 28a be installed in a cleaning area of the belt cleaning device 24. The cleaning area of the belt cleaning device 24 is an area from an upstreammost cleaning portion (in the example of FIG. 13, a first cleaning portion CL1) to a downstreammost cleaning portion (in the example of FIG. 13, a third cleaning portion CL3) in the movement direction of the intermediary transfer belt 6. Incidentally, the belt cleaning device 24 may be configured so as to remove the adhering material such as the toner from the outer surface of the intermediary transfer belt 6 in one cleaning portion. In this case, the scraper 28a may be installed at a position opposite to the one cleaning portion, which constitutes the cleaning area, via the intermediary transfer belt 6. In this manner, the belt cleaning device 24 removes the adhering material from the outer surface of the intermediary transfer belt 6 in one or a plurality of the cleaning portions in the cleaning area in the movement direction of the intermediary transfer belt 6. And the scraper 28a may be provided so as to contact the inner surface of the intermediary transfer belt 6, which corresponds to the cleaning area described above in the movement direction of the intermediary transfer belt 6. By this, as it will be described below, upon the intermediary transfer belt 6 being rotated in the state in which the potential regulating member 8 and the primary transfer roller 15 are retracted from the intermediary transfer belt 6, it becomes possible to perform the removal of the adhering material by the scraper 28a at a position at which the surface of the intermediary transfer belt 6 is relatively stable.

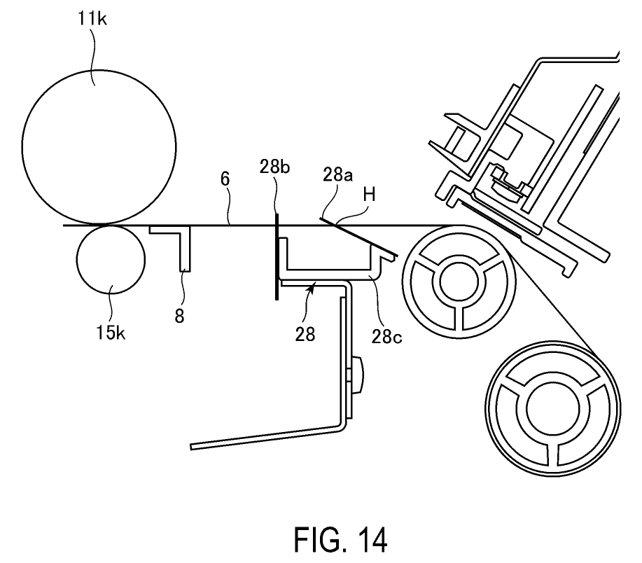

In addition, as shown in FIG. 14, it may be assumed of a case as well in which the scraper 28a may be installed only on the downstream side of the downstreammost primary transfer portion N1 (potential regulating member 8) (and on the upstream side of the secondary transfer portion N2) in the movement direction of the intermediary transfer belt 6. Even in the case of an installation position as in FIG. 14, the present invention can be applied. However, in this case, it is desirable that a time, for which the intermediary transfer belt 6 is rotated in the state in which the potential regulating member 8 is retracted from the intermediary transfer belt 6 upon starting or stopping the rotation of the intermediary transfer belt 6, which will be described below, be made longer than that in the case of the installation position as in FIG. 12. In other words, it is desirable that the rotation amount (moving amount) of the intermediary transfer belt 6 be made large.

In the present Embodiment, as shown in FIG. 12, the scraper unit 28 is provided, in the movement direction of the intermediary transfer belt 6, on the downstream side of the driving roller 21 and on the upstream side of the upstreammost primary transfer roller 15y. In the present Embodiment, the driving roller 21 is the stretching roller positioned, in the movement direction of the intermediary transfer belt 6, in an immediately near on the upstream side of the upstreammost primary transfer roller 15.

In addition, for the scraper 28a, in order to suppress that the inner surface of the intermediary transfer belt 6 is scratched thereby, it is appropriate to use, for example, a flame retardant polyester film (Mitsubishi Chemical, DIALAMY), etc. as material, and it is appropriate to configure that a thickness thereof is about 0.1 mm through 0.5 mm. In order to enhance cleaning performance of the scraper 28a, the thicker the thickness of the scraper 28a, the better, however, if the thickness is too thick, it becomes difficult for the scraper 28a to be bent, and it becomes likely for contact pressure of the scraper 28a to the intermediary transfer belt 6 to be increased. Because of this, there is a possibility that it becomes likely for abrasion of the scraper 28a to occur, and/or that it becomes likely for the inner surface of the intermediary transfer belt 6 to be scratched by the scraper 28a. In the present Embodiment, the thickness of the scraper 28a is configured to be 0.1 mm.

It is recommended that a contacting angle θ of the scraper 28a is configured to be about 5° through 30°. When the contacting angle θ is small, unevenness is generated in the contact pressure in a case in which waving occurs in the scraper 28a, causing to make it likely for slipping through of the adhering material to occur, so that the cleaning performance may be decreased. When the contacting angle θ is large, due to abrasion of an edge of the scraper 28a contacting the intermediary transfer belt 6, there is a possibility that the scratch on the inner surface of the intermediary transfer belt 6 and/or the decrease in the cleaning performance of the scraper 28a occurs. In the present Embodiment, the contacting angle θ is configured to be 25°. In addition, it is appropriate that an entering amount I of the edge of the scraper 28a to the inner surface of the intermediary transfer belt 6 be about 0.5 mm through 3.0 mm, and the entering amount I may be selected depending on stiffness, the contacting angle θ, etc. of the scraper 28a. In the present Embodiment, the entering amount I is configured to be 2.0 mm. Here, as shown in FIG. 12, the contacting angle θ is represented by an angle formed between the inner surface of the intermediary transfer belt 6, and a virtual surface of the scraper 28a in a case in which it is assumed that the scraper 28a contacts the intermediary transfer belt 6 but is not deformed. In addition, the entering amount I is represented by a distance between the inner surface of the intermediary transfer belt 6 and a virtual position of the edge of the scraper 28a contacting the intermediary transfer belt 6 in the case in which it is assumed that the scraper 28a contacts the intermediary transfer belt 6 but is not deformed. Here, in FIG. 12 through FIG. 14, the scraper 28a and the scooping sheet 28b are illustrated so as to cross the intermediary transfer belt 6, respectively, however, this schematically shows that both are brought into contact with the inner surface of the intermediary transfer belt 6 with an entering amount.

Incidentally, the inner surface cleaning member is, generally, constituted by the member having a sheet shape, a film shape or a plate shape, however, it is not limited thereto, but for example, the inner surface cleaning member may be a rotatable brush or a fixedly disposed brush, a member having a pad shape, or the like.

### 8. Inner surface cleaning operation

### 8-1. Problem

Next, an operation for cleaning the inner surface of the intermediary transfer belt 6 by the scraper 28a by causing the intermediary transfer belt 6 to be rotated in the state in which the potential regulating member 8 is separated from the inner peripheral surface (inner surface) of the intermediary transfer belt 6 (here, also referred to simply as an “inner surface cleaning operation”) will be described.

To the inner surface of the intermediary transfer belt 6 and/or a surface of the stretching roller, the adhering matter (foreign matter) may be adhered. As the adhering material, for example, one derived from an oozing matter from the primary transfer roller and/or the secondary transfer inner roller may be exemplified. For example, when NBR rubber, which is a main material of the primary transfer roller 15, reacts with ozone and/or moisture, and a double bond thereof is broken, rubber or a filler may fall off. In addition, from EPDM rubber, which is used for the driving roller 21 and/or the secondary transfer inner roller 23, process oil may ooze out due to deterioration in energization, etc. There is a case in which sticky rubber residue, which is generated by the rubber and/or the filler and the process oil reacting, is adhered to and accumulated on the inner surface of the intermediary transfer belt 6, and/or adhered to and accumulated on a surface of the driving roller 21 and/or of the secondary transfer inner roller 23. In that case, by the conveyance of the intermediary transfer belt 6 and/or an electrical characteristic of the transfer portion becoming unstable, etc., it may be a cause for image defect to occur.

Particularly, when the deterioration of rubber as described above progresses in a low humidity environment and then shifted to a high humidity environment, the adhesion phenomenon as described above may occur significantly. Furthermore, in a case in which the intermediary transfer belt 6 is stopped in the high humidity environment and contacts the various types of the rollers, the adhering material which has accumulated on the rollers is transferred to the inner surface of the intermediary transfer belt 6, and during starting up of the intermediary transfer belt 6, a state in which there is much of the adhering material on the inner surface of the intermediary transfer belt 6 may result.

### 8-2. Outline of the inner surface cleaning operation

In the image forming apparatus 1 in the present Embodiment, in order to remove the adhering material, which is adhered to the inner surface of the intermediary transfer belt 6, from the inner surface of the intermediary transfer belt 6, the scraper unit 28 is provided. As described above, the scraper unit 28 scrapes off, by the scraper 28a contacting the inner surface of the intermediary transfer belt 6, the adhering material from the inner surface of the intermediary transfer belt 6 along with the rotation of the intermediary transfer belt 6. However, immediately after the starting up of the intermediary transfer belt 6, there is an area in the inner surface of the intermediary transfer belt 6, which goes toward the primary transfer portion N1 and/or the potential regulating member 8 without passing through the inner surface cleaning portion H, which is the contact portion with the scraper 28a. Therefore, for this area in the inner surface of the intermediary transfer belt 6, the potential regulating member 8 ends up performing a role similar to that of the scraper 28a, and a leading edge on the upstream end A side of the potential regulating member 8, etc. may be contaminated by the adhering material. And when such adhering material is adhered to the potential regulating member 8 exceeding an allowable range, there is a possibility that the effect to suppress the electric discharge between the intermediary transfer belt 6 and the photosensitive drum 11 by the potential regulating member 8 is decreased.

Thus, in the present Embodiment, the image forming apparatus 1 executes, during turning a power source on (the pre-multi-rotation process) and/or during starting of a job (the pre rotation process), upon starting the rotation of the intermediary transfer belt 6, the inner surface cleaning operation causing the intermediary transfer belt 6 to be rotated in the state in which the potential regulating member 8 is separated from the inner surface of the intermediary transfer belt 6 (hereinafter, also referred to as an “inner surface cleaning operation during startup”). The inner surface cleaning operation during startup is executed by the rotation of the intermediary transfer belt 6 being started in the state in which the potential regulating member 8 is separated from the inner surface of the intermediary transfer belt 6.

By performing the inner surface cleaning operation during startup, it becomes possible to suppress that the adhering material on the inner surface of the intermediary transfer belt 6 is adhered to the potential regulating member 8 immediately after the starting the rotation of the intermediary transfer belt 6. By this, it becomes possible to suppress that the effect to suppress the electric discharge between the intermediary transfer belt 6 and the photosensitive drum 11 by the potential regulating member 8 is decreased.

An amount for which the intermediary transfer belt 6 is rotated in the state in which the potential regulating member 8 is separated from the inner surface of the intermediary transfer belt 6 in the inner surface cleaning operation during startup (hereinafter, also referred to as a “rotation amount during startup”) will be described. It is preferable that the rotation amount during startup is set so that the potential regulating member 8 can be brought into contact with an area of the inner surface of the intermediary transfer belt 6, which has passed through the inner surface cleaning portion H at least once in the inner surface cleaning operation during startup. In other words, the rotation amount during startup may be configured to be, with respect to each potential regulating member 8, from starting the rotation of the intermediary transfer belt 6 and until an area of the inner surface of the intermediary transfer belt 6, which has been in the inner surface cleaning portion H at a timing of starting the rotation of the intermediary transfer belt 6, finishes passing through a position where the area can be in contact with the potential regulating member 8.

With respect to each potential regulating member 8, in a case in which the condition described above is satisfied, it may be configured so as to sequentially bring into contact with the intermediary transfer belt 6 from the upstreammost potential regulating member 8 to a downstreammost potential regulating member 8 in the movement direction of the intermediary transfer belt 6.

In addition, in a case in which the condition described above is satisfied with respect to the plurality of potential regulating members 8, it may be configured so as to bring the plurality of potential regulating members 8 into contact with the intermediary transfer belt 6 approximately simultaneously. In this case, the rotation amount during startup may be configured to be from starting the rotation of the intermediary transfer belt 6 and until the area of the inner surface of the intermediary transfer belt 6, which has been in the inner surface cleaning portion H at the timing of starting the rotation of the intermediary transfer belt 6, finishes passing through the position where the area can be in contact with the downstreammost potential regulating member 8 in the movement direction of the intermediary transfer belt 6.

In order to make it possible to bring the potential regulating member 8 into contact with a cleaned area of the inner surface of the intermediary transfer belt 6 more reliably, it may be set as follows. That is, the rotation amount during startup may be configured to be from starting the rotation of the intermediary transfer belt 6 and until the area of the inner surface of the intermediary transfer belt 6, which has been in the inner surface cleaning portion H at the timing of starting the rotation of the intermediary transfer belt 6, finishes passing through (or reaches) a position where the area can be in contact with the stretching roller which is positioned in an immediately near downstream side of the potential regulating member 8 which is positioned downstreammost in the movement direction of the intermediary transfer belt 6 after the area passes through the position where the area can be in contact with the potential regulating member 8 which is positioned downstreammost in the movement direction. Furthermore, in order to more favorably clean the inner surface of the intermediary transfer belt 6 before bringing the potential regulating member 8 into contact, it is preferable to set as follows. That is, it is preferable that the rotation amount during startup be configured to be at least one full circumference of the intermediary transfer belt 6. In other words, the rotation amount during startup may be configured to be, at least, from starting the rotation of the intermediary transfer belt 6 and until the area of the inner surface of the intermediary transfer belt 6, which has been in the inner surface cleaning portion H at the timing of starting the rotation of the intermediary transfer belt 6, reaches the inner surface cleaning portion H next. Depending on likeliness of adhesion of the adhering material to the inner surface of the intermediary transfer belt 6, etc., the rotation amount during startup may be set more than one full circumference of the intermediary transfer belt 6. However, in order for a time taken for the inner surface cleaning operation during startup not to become too long, it is appropriate that the rotation amount during startup be ten full circumferences of the intermediary transfer belt 6 or less, and preferably five full circumferences or less, and more preferably three full circumferences or less.

In the present Embodiment, in the inner surface cleaning operation during startup during turning the power source on (the pre-multi-rotation process) and/or during starting of a job (the pre rotation process), after causing the intermediary transfer belt 6 to be rotated by at least one full circumference of the intermediary transfer belt 6 or more, the potential regulating member 8 is brought into contact with the inner surface of the intermediary transfer belt 6. Thereafter, predetermined adjusting control (adjusting operation) such as potential adjustment (for example, adjusting control for the primary transfer bias) in the pre-multi-rotation process and/or the pre rotation process is performed.

In addition, the image forming apparatus 1 may execute, during finishing the pre-multi-rotation process and/or during finishing the job (post rotation process), upon stopping the rotation of the intermediary transfer belt 6, the inner surface cleaning operation which causes the intermediary transfer belt 6 to be rotated in the state in which the potential regulating member 8 is separated from the inner surface of the intermediary transfer belt 6 (hereinafter, also referred to as an “inner surface cleaning operation during stopping”). The inner surface cleaning operation during stopping is executed, before the rotation of the intermediary transfer belt 6 is stopped, by the potential regulating member 8 being separated from the inner surface of the intermediary transfer belt 6.

By executing the inner surface cleaning operation during stopping, it becomes possible to remove the adhering material, etc., which has been accumulated between the intermediary transfer belt 6 and the potential regulating member 8 by the scraper 28a while the intermediary transfer belt 6 is rotated, from the inner surface of the intermediary transfer belt 6 before stopping the intermediary transfer belt 6. By this, it becomes possible to suppress that the accumulated adhering material, etc. described above is adhered to the inner surface of the intermediary transfer belt 6, etc. during stopping the intermediary transfer belt 6, and to make it easy for the cleaning of the inner surface of the intermediary transfer belt 6 upon starting up the intermediary transfer belt 6 next.

An amount for which the intermediary transfer belt 6 is rotated in the state in which the potential regulating member 8 is separated from the inner surface of the intermediary transfer belt 6 in the inner surface cleaning operation during stopping (hereinafter, also referred to as a “rotation amount during stopping”) will be described. It is preferable that the rotation amount during stopping is set so that the rotation of the intermediary transfer belt 6 can be stopped after the inner surface of the intermediary transfer belt 6 passes through the inner surface cleaning portion H at least once over an entire circumference in the inner surface cleaning operation during stopping. That is, the rotation amount during stopping may be configured to be, at least, from when the potential regulating member 8 is separated from the inner surface of the intermediary transfer belt 6 and until the intermediary transfer belt 6 is rotated by one full circumference. Depending on the likeliness of the adhesion of the adhering material to the inner surface of the intermediary transfer belt 6, etc., the rotation amount during stopping may be set to more than one full circumference of the intermediary transfer belt 6. However, in order for a time taken for the inner surface cleaning operation during stopping not to become too long, it is appropriate that the rotation amount during stopping be ten full circumferences of the intermediary transfer belt 6 or less, and preferably five full circumferences or less, and more preferably three full circumferences or less.

Incidentally, in the present Embodiment, in a state in which the scraper unit 28 is mounted to the intermediary transfer unit 20, the scraper 28a substantially always contacts the inner surface of the intermediary transfer belt 6. However, it is not limited thereto, but it is sufficient that it is configured that the scraper 28a contacts the inner surface of the intermediary transfer belt 6 at least upon the intermediary transfer belt 6 being rotated.

In addition, during inner surface cleaning operation, in the state in which the potential regulating member 8 is retracted from the intermediary transfer belt 6, a cleaning bias may be applied to the cleaning portions CL1 and CL2 of the belt cleaning device 24, and to the secondary transfer portion N2. Incidentally, the cleaning bias applied to the secondary transfer portion N2 may be configured to be a bias having opposite polarity to the secondary transfer bias applied to the secondary transfer portion N2 during secondary transfer. For example, in a case in which the secondary transfer bias having positive polarity is applied to the secondary transfer outer roller 25 during secondary transfer, the cleaning bias having negative polarity is applied to the secondary transfer outer roller 25. By this, it becomes possible to cause the toner adhered to the secondary transfer outer roller 25 to be moved to the intermediary transfer belt 6, and thereafter, to be collected from the intermediary transfer belt 6 by the belt cleaning device 24. On the other hand, during inner surface cleaning operation, it is configured that a bias is not applied to the primary transfer roller 15 which is caused to be retracted from the intermediary transfer belt 6.

In addition, in the present Embodiment, the primary transfer roller 15 is retracted from the intermediary transfer belt 6 during inner surface cleaning operation, however, the present invention is not limited to such an embodiment. In a case in which the potential regulating member 8 can contact and be separated from the intermediary transfer belt 6 independently of the primary transfer roller 15, it is not necessary for the primary transfer roller 15 to be retracted from the intermediary transfer belt 6 during inner surface cleaning operation. From a viewpoint of suppressing the adhesion of the adhering material to the primary transfer roller 15, etc., it is preferable that the primary transfer roller 15 is retracted from the intermediary transfer belt 6 during inner surface cleaning operation as in the present Embodiment. However, it is more likely for the adhering material to be adhered to the potential regulating member 8 due to a reason of a shape thereof, etc. Therefore, an appropriate effect may still be obtained by only the potential regulating member 8 of the primary transfer roller 15 and the potential regulating member 8 being retracted from the intermediary transfer belt 6 during inner surface cleaning operation.

In addition, during inner surface cleaning operation, in a case in which by the primary transfer roller 15 being separated from the intermediary transfer belt 6, the intermediary transfer belt 6 is separated from the photosensitive drum 11, during inner surface cleaning operation, the photosensitive drum 11 may be caused to be stopped. During inner surface cleaning operation, in a case in which the intermediary transfer belt 6 contacts the photosensitive drum 11, such as a case in which the primary transfer roller 15 is not separated from the intermediary transfer belt 6, it is sufficient to cause, during inner surface cleaning operation, the photosensitive drum 11 to be rotated.

### 8-3. Operation during turning the power source on in a case in which the inner surface cleaning operation is not performed (Comparative Example)

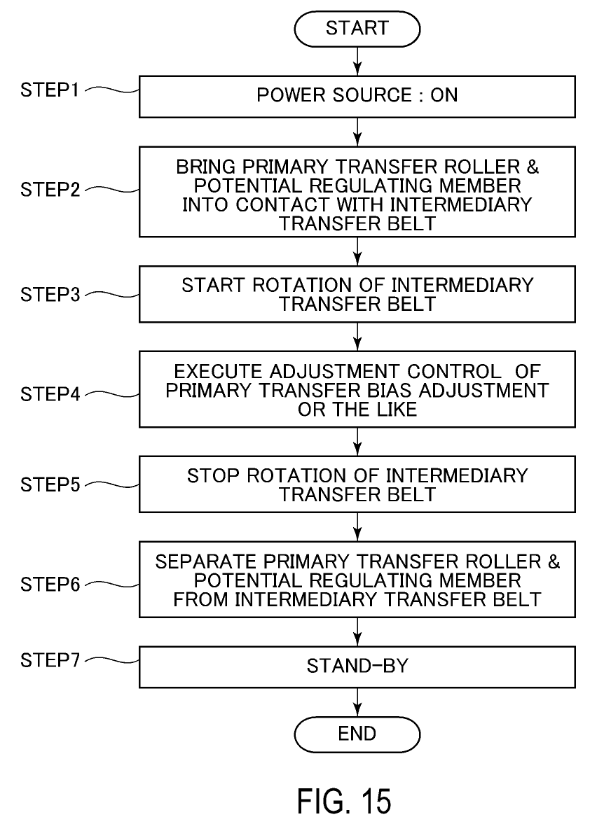

First, for comparison with a sequence in the present Embodiment, an operation during turning the power source on in a case in which the inner surface cleaning operation is not performed will be described. FIG. 15 is a flowchart diagram showing an outline of a sequence in this case. Incidentally, it is assumed that even though the inner surface cleaning operation is not performed, a configuration of the image forming apparatus 1 is substantially the same as that of the image forming apparatus 1 in the present Embodiment. In addition, here, it is assumed that contact/separation operation of the primary transfer roller 15 and the potential regulating member 8 with respect to the intermediary transfer belt 6 in each primary transfer portion N1 is performed synchronously (substantially simultaneously).

Step 1: The power source of the image forming apparatus 1 is turned on.

Step 2: The control portion 3 controls the contact/separation mechanism 29 so as to cause the primary transfer roller 15 and the potential regulating member 8 to be moved to the positions at which each contacts the intermediary transfer belt 6.

Step 3: The control portion 3 controls the belt driving portion 92 so as to cause the rotation of the intermediary transfer belt 6 to be started.

Step 4: The control portion 3 executes the adjusting control of the primary transfer bias and other adjusting controls. Incidentally, in the adjusting control for the primary transfer bias, applications of the primary transfer bias and the potential regulating bias are performed.

Step 5: The control portion 3 controls the belt driving portion 92 so as to cause the rotation of the intermediary transfer belt 6 to be stopped.

Step 6: The control portion 3 controls the contact/separation mechanism 29 so as to cause the primary transfer roller 15 and the potential regulating member 8 to be moved to the positions at which each does not contact the intermediary transfer belt 6.

Step 7: The control portion 3 causes the image forming apparatus 1 to be transitioned to the standby state.

### 8-4. Operation during turning the power source on in a case in which the inner surface cleaning operation is performed (Present Embodiment)

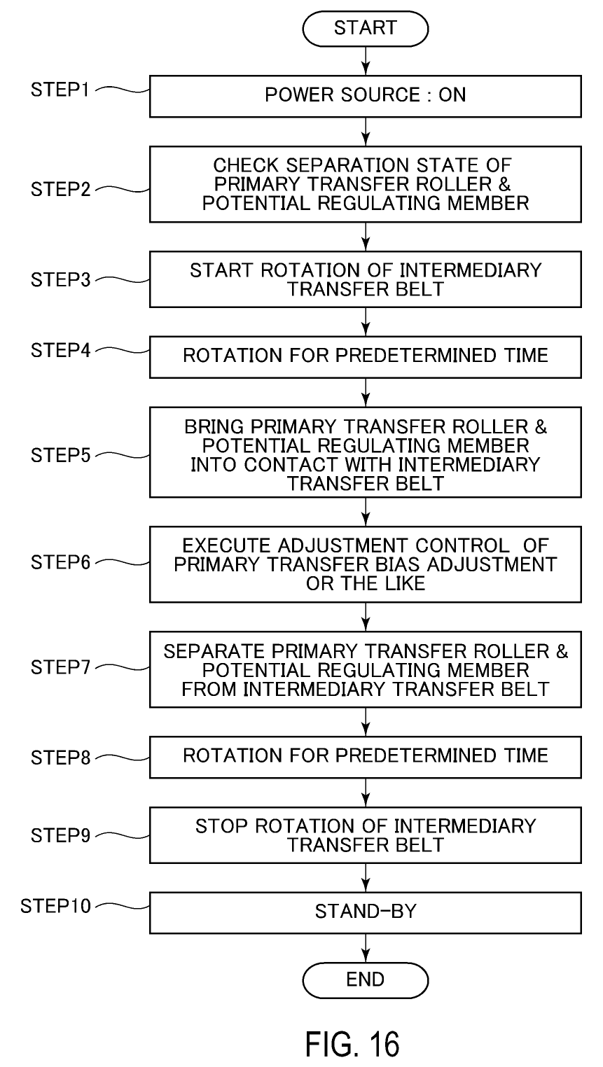

Next, an operation during turning the power source on in a case in which the inner surface cleaning operation in the present Embodiment is performed will be described. FIG. 16 is a flowchart diagram showing an outline of a sequence in this case. Incidentally, here, it is assumed that contact/separation operation of the primary transfer roller 15 and the potential regulating member 8 with respect to the intermediary transfer belt 6 in each primary transfer portion N1 is performed synchronously (substantially simultaneously).

Step 1: The power source of the image forming apparatus 1 is turned on.

Step 2: The control portion 3 executes, in order to make sure that the primary transfer roller 15 and the potential regulating member 8 are at the positions at which each does not contact the intermediary transfer belt 6, a retracting operation of the primary transfer roller 15 and the potential regulating member 8 from the intermediary transfer belt 6. Incidentally, in a case in which it is certain that the primary transfer roller 15 and the potential regulating member 8 are at the positions at which each does not contact the intermediary transfer belt 6 during turning the power source off of the image forming apparatus 1, in a case in which it is confirmed by other means, etc., the process of this step may be omitted.

Step 3: The control portion 3 controls the belt driving portion 92 so as to cause the rotation of the intermediary transfer belt 6 to be started.

Step 4: The control portion 3 controls the belt driving portion 92 so as to execute the inner surface cleaning operation over a predetermined time (cause the intermediary transfer belt 6 to be rotated over the predetermined time). For example, the predetermined time here is configured to be the time from starting the rotation of the intermediary transfer belt 6 and until the intermediary transfer belt 6 is rotated by one full circumference.

Step 5: The control portion 3 controls the contact/separation mechanism 29 so as to cause the primary transfer roller 15 and the potential regulating member 8 to be moved to the positions at which each contacts the intermediary transfer belt 6.

Step 6: The control portion 3 executes, after the rotation of the intermediary transfer belt 6 stabilizes, the adjusting control of the primary transfer bias and other adjusting controls. Incidentally, in the adjusting control for the primary transfer bias, the applications of the primary transfer bias and the potential regulating bias are performed.

Step 7: The control portion 3 controls the contact/separation mechanism 29 so as to cause the primary transfer roller 15 and the potential regulating member 8 to be moved to the positions at which each does not contact the intermediary transfer belt 6.

Step 8: The control portion 3 controls the belt driving portion 92 so as to execute the inner surface cleaning operation over a predetermined time (cause the intermediary transfer belt 6 to be rotated over the predetermined time). For example, the predetermined time here is configured to be the time from starting the rotation of the intermediary transfer belt 6 and until the intermediary transfer belt 6 is rotated by one full circumference.

Step 9: The control portion 3 controls the belt driving portion 92 so as to cause the rotation of the intermediary transfer belt 6 to be stopped.

Step 10: The control portion 3 causes the image forming apparatus 1 to be transitioned to the standby state.

### 8-5. Job operation in the case in which the inner surface cleaning operation is performed (Present Embodiment)

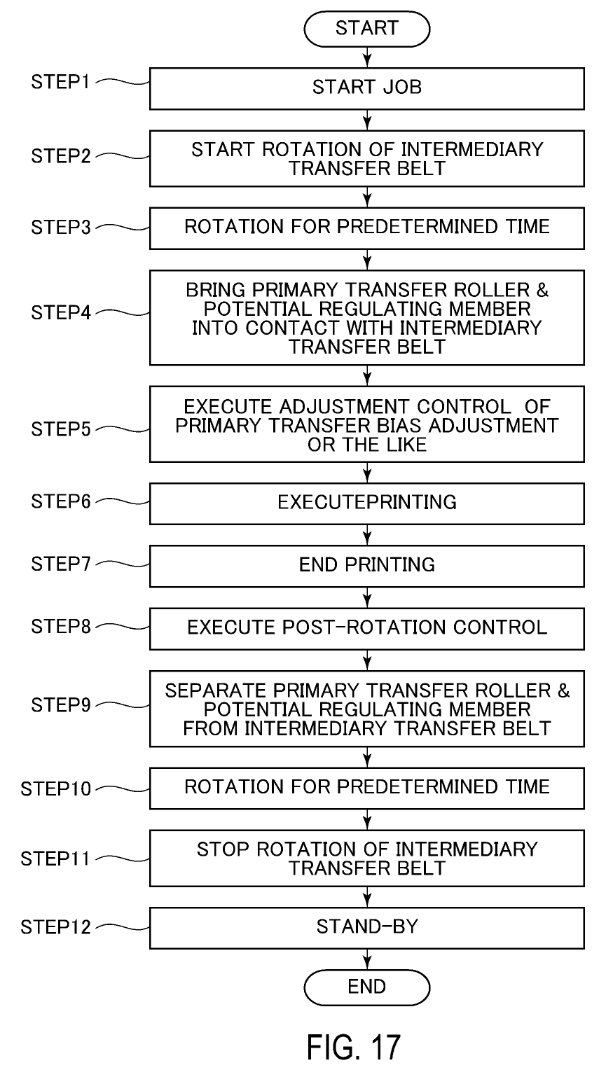

Next, a job operation in the case in which the inner surface cleaning operation in the present Embodiment is performed will be described. FIG. 17 is a flowchart diagram showing an outline of a sequence in this case. Incidentally, here, it is assumed that contact/separation operation of the primary transfer roller 15 and the potential regulating member 8 with respect to the intermediary transfer belt 6 in each primary transfer portion N1 is performed synchronously (substantially simultaneously).

Step 1: The control portion 3 causes, when a job is input, the job to be started.

Step 2: The control portion 3 controls the belt driving portion 92 so as to cause the rotation of the intermediary transfer belt 6 to be started. Incidentally, before causing the rotation of the intermediary transfer belt 6 to be started, similar to Step 2 in FIG. 16, the step for confirming that the primary transfer roller 15 and the potential regulating member 8 are at the positions at which each does not contact the intermediary transfer belt 6 may be provided.

Step 3: The control portion 3 controls the belt driving portion 92 so as to execute the inner surface cleaning operation over a predetermined time (cause the intermediary transfer belt 6 to be rotated over the predetermined time). For example, the predetermined time here is configured to be the time from starting the rotation of the intermediary transfer belt 6 and until the intermediary transfer belt 6 is rotated by one full circumference.

Step 4: The control portion 3 controls the contact/separation mechanism 29 so as to cause the primary transfer roller 15 and the potential regulating member 8 to be moved to the positions at which each contacts the intermediary transfer belt 6.

Step 5: The control portion 3 executes, after the rotation of the intermediary transfer belt 6 stabilizes, various types of adjusting controls such as the adjusting control for the primary transfer bias. Incidentally, in the adjusting control for the primary transfer bias, the applications of the primary transfer bias and the potential regulating bias are performed.

Step 6: The control portion 3 controls each portion of the image forming apparatus 1 so as the printing (image formation) to be executed.

Step 7: The control portion 3 causes the printing for all images in the job to be completed.

Step 8: The control portion 3 executes a control in the post rotation process. Here, the control in the post rotation process is not particularly limited, however, for example, an adjusting control, which is performed in a case in which an accumulated number of printed sheets reaches a predetermined value, etc. may be exemplified. Here, in a case in which there is no control to be particularly executed, it may be proceeded to the next Step 9 subsequently to Step 7.

Step 9: The control portion 3 controls the contact/separation mechanism 29 so as to cause the primary transfer roller 15 and the potential regulating member 8 to be moved to the positions at which each does not contact the intermediary transfer belt 6.

Step 10: The control portion 3 controls the belt driving portion 92 so as to execute the inner surface cleaning operation over a predetermined time (cause the intermediary transfer belt 6 to be rotated over the predetermined time). For example, the predetermined time here is configured to be the time from starting the rotation of the intermediary transfer belt 6 and until the intermediary transfer belt 6 is rotated by one full circumference.

Step 11: The control portion 3 controls the belt driving portion 92 so as to cause the rotation of the intermediary transfer belt 6 to be stopped.

Step 12: The control portion 3 causes the image forming apparatus 1 to be transitioned to the standby state.

### 8-6. Adjustment of the rotation amount of the intermediate transfer belt in the inner surface cleaning operation

Depending on an environment, the amount for which the intermediary transfer belt 6 is rotated in the state in which the potential regulating member 8 is separated from the inner surface of the intermediary transfer belt 6 in the inner surface cleaning operation (here, also referred to as an “inner surface cleaning rotation amount”) may be changed. Particularly, in a case in which the image forming apparatus 1 is operated in a high humidity environment, it is preferable that the inner surface cleaning rotation amount be set larger than that in a case in which the image forming apparatus 1 is operated in a low humidity environment or a normal humidity environment. This is because, as described above, it can be considered that, in the high humidity environment, it is more likely for the adhesion of the adhering material to the inner surface of the intermediary transfer belt 6 to occur than in the low humidity environment or the normal humidity environment. Here, as the inner surface cleaning rotation amount, at least one of the rotation amount during startup and the rotation amount during stopping may be changed depending on the environment. The control portion 3 may perform the following processes, in at least one of Step 4 and Step 8 in FIG. 16, and/or at least one of Step 3 and Step 10 in FIG. 17. For example, the control portion 3 calculates, as information associated with a humidity of an environment, an absolute humidity based on a temperature and a humidity obtained from the temperature sensor 71 and the humidity sensor 72. And, the control portion 3 sets, based on the calculated absolute humidity, in a case in which it is an environment in which the absolute humidity is higher than a predetermined value, the inner surface cleaning rotation amount larger than one full circumference of the intermediary transfer belt 6 (for example, three through five full circumferences). In addition, the control portion 3 sets, in a case in which it is an environment in which the calculated absolute humidity is the predetermined value or less, the inner surface cleaning rotation amount at least one full circumference of the intermediary transfer belt 6. For example, the predetermined value (threshold value) for the absolute humidity described above may be configured to be 16 g/m³ or more. Incidentally, for example, it may be configured that a plurality of the threshold values for the absolute humidity are set, and the inner surface cleaning rotation amount is changed in three or more stages depending on the environment. In addition, it may be configured that by using a table data which shows a relationship between the environment (absolute humidity) and the inner surface cleaning rotation amount, etc., the inner surface cleaning rotation amount corresponding to the environment is selected and used. As such, the control portion 3 may control so that, for example, the inner surface cleaning rotation amount becomes larger in a case in which a humidity of an environment is a second humidity higher than a first humidity than in a case in which the humidity is the first humidity.

In addition, the inner surface cleaning rotation amount may be changed based on usage amount information (usage history information) such as an accumulated usage amount of the intermediary transfer belt 6 and an accumulated usage amount of the primary transfer roller 15. This is because the likeliness of the adhesion of the adhering material to the inner surface of the intermediary transfer belt 6 may change due to deterioration, etc. through use of the intermediary transfer belt 6, the stretching roller, the primary transfer roller 15, or the like. For the usage amount information, an arbitrary index value, which correlates with the accumulated usage amount of the intermediary transfer belt 6, the stretching roller, or the primary transfer roller 15, may be used. As the index value, an accumulated number of printed sheets, a number of rotations and a rotation time of the intermediary transfer belt 6 (or the stretching roller or the primary transfer roller 15), etc. may be exemplified. For example, there is a case in which it is preferable that the inner surface cleaning rotation amount be set larger as the accumulated number of printed sheets from when the intermediary transfer belt 6 is new gets larger. Here, as the inner surface cleaning rotation amount, at least one of the rotation amount during startup and the rotation amount during stopping may be changed depending on the accumulated usage amount of the intermediary transfer belt 6, etc. The control portion 3 may perform the following process, in at least one of Step 4 and Step 8 in FIG. 16, and/or at least one of Step 3 and Step 10 in FIG. 17. For example, the control portion 3 gets, as the information associated with the accumulated usage amount of the intermediary transfer belt 6, the accumulated number of printed sheets of the intermediary transfer belt 6, which is sequentially updated and stored in a storage portion such as a non-volatile memory (not shown) provided in the control portion 3. And the control portion 3 sets, in a case in which the obtained number of printed sheets is larger than a predetermined value, the inner surface cleaning rotation amount larger than one full circumference of the intermediary transfer belt 6 (for example, three through five full circumferences).

In addition, the control portion 3 sets, in a case in which the obtained number of printed sheets is the predetermined value described above or less, the inner surface cleaning rotation amount at least one full circumference of the intermediary transfer belt 6. Incidentally, for example, it may be configured that a plurality of threshold values for the usage amount information are set, and the inner surface cleaning rotation amount is changed in three or more stages depending on the usage amount information. In addition, it may be configured that by using a table data which shows a relationship between the usage amount information and the inner surface cleaning rotation amount, etc., the inner surface cleaning rotation amount corresponding to the usage amount information may be selected and used. As such, the control portion 3 may control so that, for example, the inner surface cleaning rotation amount becomes larger in a case in which the accumulated usage amount of the intermediary transfer belt 6, etc. is a second usage amount larger than a first usage amount than in a case in which the accumulated usage amount is the first usage amount.

### 8-7. User mode

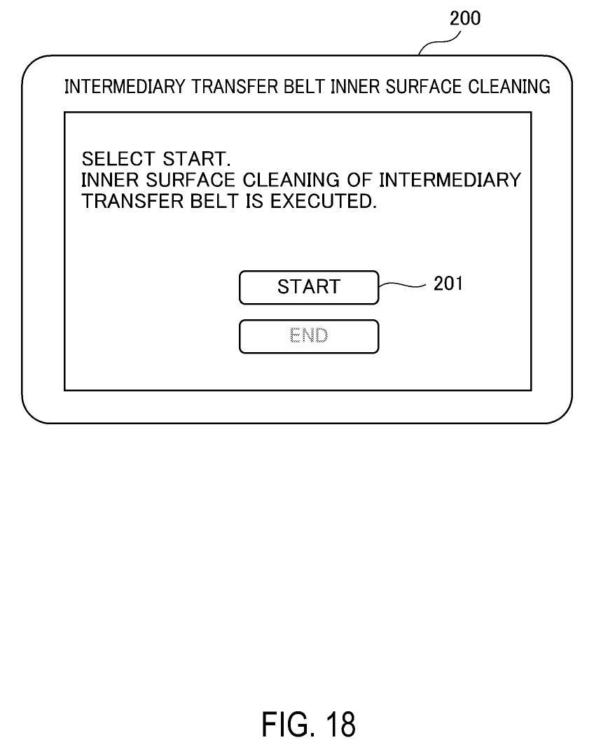

In addition, the image forming apparatus 1 may be configured so that an operator such as a user and a service representative may arbitrarily cause the image forming apparatus 1 to execute the inner surface cleaning operation. For example, the image forming apparatus 1 is configured so as to be capable of displaying, on the display portion 70a of the operating portion 70, as a user mode screen, an operating screen for an intermediary transfer belt inner surface cleaning mode, through which the inner surface cleaning operation may be caused to be executed. And it may be configured that the operator may perform, when the image forming apparatus 1 is in the standby state, before executing a job, for example, to cause the inner surface cleaning operation to be performed by arbitrarily operating this operating screen. FIG. 18 is a schematic view illustrating an example of the user mode screen. The operator may input, through a predetermined operation in the operating portion 70, an instruction to the control portion 3 to display a user mode screen 200 as shown in FIG. 18 on the display portion 70a. And, the control portion 3 performs the control, in response to the operator operating (touching) a start button 201 on the user mode screen 200, so as to execute the inner surface cleaning operation. Incidentally, it may be configured so that, instead of or in addition to inputting from an input portion of the operating portion 70, an instruction similar to the above may be input to the control portion 3 from the external device. In this case, an input/output circuit, which inputs information from the external device to the control portion 3, etc. functions as an input portion which inputs the instruction to the control portion 3.

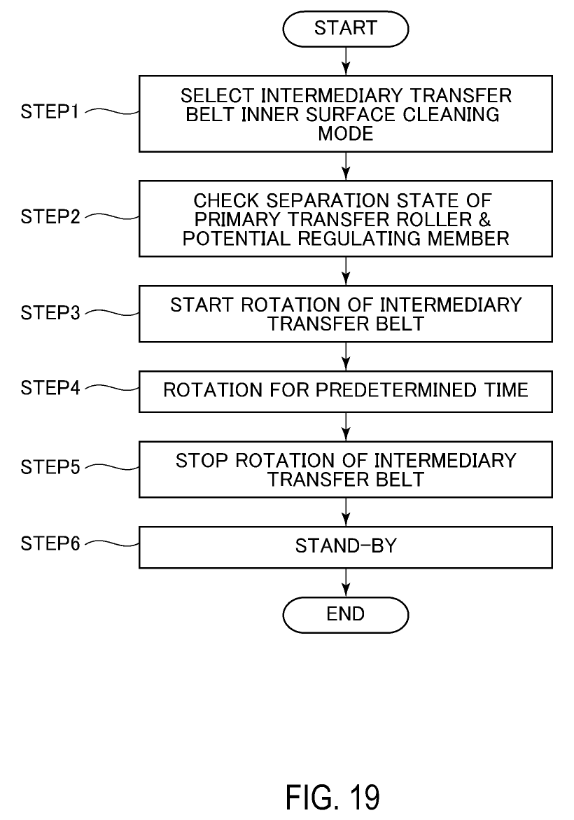

FIG. 19 is a flowchart diagram showing an outline of a sequence of the intermediary transfer belt inner surface cleaning mode. Incidentally, here, it is assumed that contact/separation operation of the primary transfer roller 15 and the potential regulating member 8 with respect to the intermediary transfer belt 6 in each primary transfer portion N1 is performed synchronously (substantially simultaneously).

Step 1: The control portion 3 gets information (a signal) indicating that starting of the intermediary transfer belt inner surface cleaning mode is selected through the user mode screen 200.

Step 2: The control portion 3 executes, in order to make sure that the primary transfer roller 15 and the potential regulating member 8 are at the positions at which each does not contact the intermediary transfer belt 6, the retraction operation of the primary transfer roller 15 and the potential regulating member 8 from the intermediary transfer belt 6. Incidentally, in a case in which it is certain that the primary transfer roller 15 and the potential regulating member 8 are at the positions at which each does not contact the intermediary transfer belt 6 during stopping the intermediary transfer belt 6, in the case in which it is confirmed by other means, etc., the process of this step may be omitted.

Step 3: The control portion 3 controls the belt driving portion 92 so as to cause the rotation of the intermediary transfer belt to be started.

Step 4: The control portion 3 controls the belt driving portion 92 so as to execute the inner surface cleaning operation over a predetermined time (cause the intermediary transfer belt 6 to be rotated over the predetermined time). For example, the predetermined time here is configured to be the time from starting the rotation of the intermediary transfer belt 6 and until the intermediary transfer belt 6 is rotated by one full circumference. Incidentally, as described above, the inner surface cleaning rotation amount in this case may be changed depending on the environment and/or the accumulated usage amount of the intermediary transfer belt 6, etc. In addition, it may be configured that on the user mode screen 200, the inner surface cleaning rotation amount can be selected (changed). In this case, it may be configured that, not limited to the rotation amount (rotation time) of the intermediary transfer belt 6 can be directly selected (designated), but also a cleaning level such as “strong/weak” of a cleaning effect and “long/short” of a cleaning time can be selected (designated). In addition, it may be configured that the operator can cause the inner surface cleaning operation to be ended at an arbitrary timing.

Step 5: The control portion 3 controls the belt driving portion 92 so as to cause the rotation of the intermediary transfer belt 6 to be stopped.

Step 6: The control portion 3 causes the image forming apparatus 1 to be transitioned to the standby state.

### 9. Confirming effect

Next, results of having verified effects of the present Embodiment will be described. Here, a change in an electrical characteristic of the potential regulating member 8 due to the adhesion of the adhering material to the potential regulating member 8 is examined through an increase of an electric discharge voltage necessary for obtaining a predetermined electric discharge current. In addition, a change in the effect to suppress a partial increase of the charge amount of the toner on the intermediary transfer belt 6 due to the adhesion of the adhering material to the potential regulating member 8 is examined through the transfer performance of the toner image to an embossed paper. Specifically, the following experiment was performed.

In an environment of a normal temperature and a low humidity (23°C, 5%Rh), one hundred thousand sheets of plain papers are passed, and thereafter, in an environment of a high temperature and a high humidity (28°C, 75%Rh), twenty thousand sheets of plain papers are passed. A number of sheets passed per day is set to twenty thousand sheets. In addition, a sheet passing mode is set so that the intermediary transfer belt 6 is stopped for each job of one thousand sheets and the post rotation is performed before the stop. In addition, it is set that a next job is performed from the standby state.

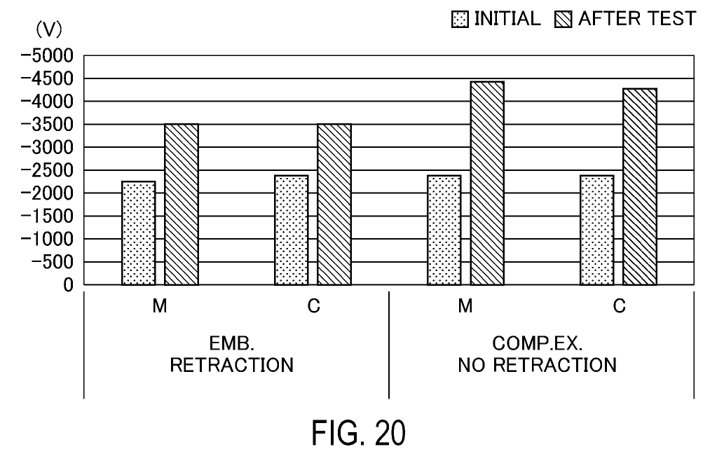

During this sheet passing endurance test, the flow in FIG. 17 is repeatedly executed. And this sheet passing endurance tests are performed in a case in which the inner surface cleaning operation, in which the potential regulating member 8 is retracted from the intermediary transfer belt 6 and the intermediary transfer belt 6 is rotated, is performed (the present Embodiment), and in a case in which the inner surface cleaning operation is not performed (the Comparative Example). FIG. 20 shows applied voltages to the potential regulating member 8 required for obtaining the predetermined electric discharge current at 23°C at an initial stage of this sheet passing endurance test and after the endurance.

From FIG. 20, it is found that, with the potential regulating member 8 at the initial stage, which is not contaminated by the adhering material, an appropriate applied voltage is about -2000 V through -3000 V. On the other hand, with the contaminated potential regulating member 8 after the endurance, the applied voltage required for obtaining the predetermined electric discharge current is increased. It can be considered to be due to the adhering material having accumulated on the edge of the potential regulating member 8. However, from FIG. 20, it is found that this increase in the applied voltage is suppressed in the present Embodiment more than in the Comparative Example.

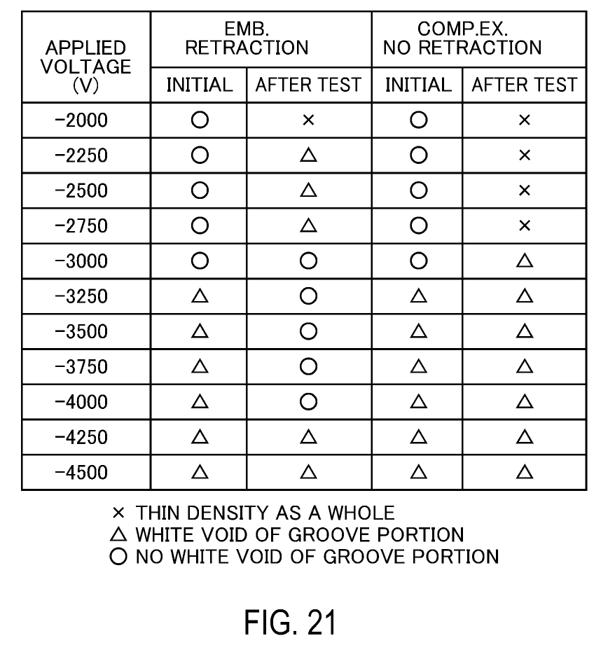

In addition, in the present Embodiment and the Comparative Example, transferred states of solid images of secondary colors of magenta and cyan on LEATHAC (Trademark), which is an embossed paper with 250 g/m², in the initial state and after the endurance of the paper passing endurance test described above are examined. With varying a voltage applied to the potential regulating member 8 during image formation, the transfer states are examined, respectively (voltages applied to the potential regulating members 8, which are provided to respective image forming units, during image formation are set constant.). Results thereof are shown in FIG. 21. “Ο” indicates a state in which an overall density is sufficient, the toner is transferred both to a flat surface portion and a groove portion, and there is no uneven density. “×” indicates a state in which the transfer current is insufficient and a density is light overall. “Δ” indicates a state in which the density in the flat surface portion is sufficient but the toner is not transferred to the groove portion, resulting in a white void.

From FIG. 21, in the present Embodiment, it is found that the applied voltage to the potential regulating member 8 for obtaining an appropriate transfer state is increased after the endurance, however, there is a sufficient range of voltage in which the void of transfer does not occur even in the groove portion. Incidentally, in a range in which the voltage is low, by the toner for the groove portion not being able to be transferred, magenta cannot be transferred thereto, so that a tone of a color, in which cyan is strong, results. In addition, in a range in which the voltage is high, by the gap electric discharge occurring in the groove portion, the toner cannot be transferred thereto, so that an image, in which the groove portion becomes the white void, results. In addition, from FIG. 21, in the Comparative Example, it is found that due to the potential regulating member 8 being contaminated by the adhering material after the endurance, even if the applied voltage to the potential regulating member 8 is raised, sufficient effect to suppress the electric discharge cannot be obtained, so that it is difficult to eliminate the white void at the groove portion. In other words, in the present Embodiment, when the applied voltage to the potential regulating member 8 is set to an appropriate value, the transfer to the groove portion in the embossed paper becomes possible even after the endurance, however, in the Comparative Example, it is difficult to eliminate the white void at the groove portion after the endurance.

In this manner, in the present Embodiment, the image forming apparatus 1 includes the photosensitive member (photosensitive drum) 11 which is capable of being electrically charged to the predetermined polarity and bears the toner image, and the intermediary transfer belt 6 which is stretched by the plurality of stretching rollers and conveys the toner image, primarily transferred from the photosensitive member 11 in the primary transfer portion N1 which is in contact with the photosensitive member 11, to secondarily transfer onto the recording material S in the secondary transfer portion N2, and capable of being circulated and moved, the primary transfer member (primary transfer roller) 15 which forms the primary transfer portion N1, is in contact with the inner surface of the intermediary transfer belt 6, and transfers the toner image from the photosensitive member 11 onto the intermediary transfer belt 6 in the primary transfer portion N1 under application of the bias, the electrode member (potential regulating member) 8 which is provided on the side downstream of the primary transfer portion N1 with respect to the movement direction of the intermediary transfer belt 6 and so as to be in contact with the inner surface of the intermediary transfer belt 6, the power source (potential regulating power source) 80 which applies the bias of the same polarity as the predetermined polarity to the electrode member 8, the inner surface cleaning member (scraper) 28a which is in contact with the inner surface of the intermediary transfer belt 6 at the inner surface cleaning portion H, and removes the adhering material from the inner surface of the intermediary transfer belt 6, the driving portion (belt driving portion) 92 which drives the intermediary transfer belt 6, the contact/separation mechanism 29 which moves the electrode member 8 between the first position to be in contact with the inner surface of the intermediary transfer belt 6 and the second position not to be in contact with the inner surface of the intermediary transfer belt 6, and the control portion 3 which can control the driving portion 92 and the contact/separation mechanism 29. And, in the present Embodiment, the control portion 3 controls so as to start the rotation of the intermediary transfer belt 6 in the state in which the electrode member 8 is caused to be in the second position when the control portion 3 causes the intermediary transfer belt 6 to be rotated from the state in which the intermediary transfer belt 6 is stopped.

In the present Embodiment, in the case in which the control portion 3 causes the intermediary transfer belt 6 to be rotated from the state in which the intermediary transfer belt 6 is stopped in response to turning on of the power source of the image forming apparatus 1, the control portion 3 controls so as to start the rotation of the intermediary transfer belt 6 in the state in which the electrode member 8 is caused to be in the second position and the control portion 3 moves the electrode member 8 from the second position to the first position after the rotation amount of the intermediary transfer belt 6 reaches a predetermined rotation amount from starting the rotation of the intermediary transfer belt 6. In addition, in the present Embodiment, in the case in which the control portion 3 rotates the intermediary transfer belt 6 from the state in which the intermediary transfer belt 6 is stopped in response to the input of the start instruction of the image formation, the control portion 3 controls so as to start the rotation of the intermediary transfer belt 6 in the state in which the electrode member 8 is caused to be in the second position and the control portion 3 moves the electrode member 8 from the second position to the first position after the rotation amount of the intermediary transfer belt 6 reaches a predetermined rotation amount from starting the rotation of the intermediary transfer belt 6 and before starting the image formation. In addition, it may be configured that the control portion 3 is capable of controlling to execute the operation in the mode (intermediary transfer belt inner surface cleaning mode) in which the inner surface of the intermediary transfer belt 6 is cleaned by the inner surface cleaning member 28a by rotating the intermediary transfer belt 3, and the input portion (operating portion) 70 which inputs the start instruction of the mode to the control portion 3 based on the operation of an operator is provided. In this case, in the case in which the control portion 3 causes the intermediary transfer belt 6 to be rotated from the state in which the intermediary transfer belt 6 is stopped in response to input of the start instruction of the mode, the control portion 3 controls so as to start the rotation of the intermediary transfer belt 6 in the state in which the electrode member 8 is caused to be in the second position and the control portion 3 stops the rotation of the intermediary transfer belt 6 in the state in which the electrode member 8 is caused to be in the second position after the rotation amount of the intermediary transfer belt 6 reaches a predetermined rotation amount. For example, the predetermined rotation amount described above is the rotation amount from starting the rotation of the intermediary transfer belt 6 and until the area of the inner surface of the intermediary transfer belt 6, which has been in the inner surface cleaning portion H at the timing of starting the rotation of the intermediary transfer belt 6, passes through the position where the area is in contact with the electrode member 8. In addition, in the present Embodiment, the image forming apparatus 1 includes the plurality of photosensitive members 11, the plurality of primary transfer members 15 provided corresponding to the plurality of photosensitive members 11, respectively, and the plurality of electrode members 8 provided corresponding to the plurality of photosensitive members 11, respectively. In this case, for example, the predetermined rotation amount described above is the rotation amount from starting the rotation of the intermediary transfer belt 6 and until the area of the inner surface of the intermediary transfer belt 6, which has been in the inner surface cleaning portion H at the timing of the starting the rotation of the intermediary transfer belt 6, passes through the position where the area is in contact with the electrode member 8 which is positioned downstreammost in the movement direction of the intermediary transfer belt 6. In addition, for example, the predetermined rotation amount described above may be the rotation amount from starting the rotation of the intermediary transfer belt 6 and until the area of the inner surface of the intermediary transfer belt 6, which has been in the inner surface cleaning portion H at the timing of starting the rotation of the intermediary transfer belt 6, passes through the position where the area is in contact with the stretching roller which is positioned in the immediately near downstream side of the electrode member 8 which is positioned downstreammost in the movement direction of the intermediary transfer belt 6 after the area passes through the position where the area is in contact with the electrode member 8 which is positioned downstreammost in the movement direction. In addition, for example, the predetermined rotation amount described above is at least one full circumference of the intermediary transfer belt 6 from starting the rotation of the intermediary transfer belt 6. In addition, it may be configured that the control portion 3 is capable of changing the predetermined rotation amount based on the information on the humidity of the environment. In addition, it may be configured that the control portion 3 is capable of changing the predetermined rotation amount based on the information on the accumulated usage amount of the intermediary transfer belt 6. In addition, it may be configured that the control portion 3 is capable of changing the predetermined rotation amount based on the information on the accumulated usage amount of the primary transfer member 15.

In addition, in the present Embodiment, when the control portion 3 stops the rotation of the intermediary transfer belt 6 from the state in which the electrode member 8 is caused to be in the first position and the intermediary transfer belt 6 is caused to be rotated, the control portion 3 controls so as to stop the rotation of the intermediary transfer belt 6 after the electrode member 8 is caused to be moved from the first position to the second position and the intermediary transfer belt 6 is caused to be rotated in the state in which the electrode member 8 is caused to be positioned in the second position. In addition, in the present Embodiment, when the control portion 3 stops the rotation of the intermediary transfer belt 6 from the state in which the electrode member 8 is caused to be in the first position and the intermediary transfer belt 6 is caused to be rotated, the control portion 3 controls so as to stop the rotation of the intermediary transfer belt 6 after the rotation amount of the intermediary transfer belt 6 reaches the predetermined rotation amount from when the electrode member 8 is caused to be in the second position. In this case, for example, the predetermined rotation amount is at least one full circumference of the intermediary transfer belt 6 from when the electrode member 8 is caused to be in the second position. In addition, in this case as well, it may be configured that the control portion 3 is capable of changing the predetermined rotation amount based on the information on the humidity of the environment, the information on the accumulated usage amount of the intermediary transfer belt 6, or the information on the accumulated usage amount of the primary transfer member 15.

In addition, in the present Embodiment, the image forming apparatus 1 includes the plurality of photosensitive members 11, the plurality of primary transfer members 15 provided corresponding to the plurality of photosensitive members 11, respectively, and the plurality of electrode members 8 provided corresponding to the plurality of photosensitive members 11, respectively, and the inner surface cleaning member 28a is provided on the side downstream of the stretching roller which is positioned in the immediately near upstream side of the primary transfer member 15 which is positioned upstreammost in the movement direction of the intermediary transfer belt 6 and the side upstream of the primary transfer member 15 which is positioned upstreammost in the movement direction. In addition, in the present Embodiment, the contact/separation mechanism 29 moves the primary transfer member 15 between the third position where the primary transfer member 15 is in contact with the inner surface of the intermediary transfer belt 6 and the fourth position where the primary transfer member 15 is not in contact with the inner surface of the intermediary transfer belt 6, and the contact/separation mechanism 29 causes the primary transfer member 15 to be positioned at the third position when the electrode member 8 is caused to be in the first position, and to be positioned at the fourth position when the electrode member 8 is caused to be in the second position.

As described above, according to the present Embodiment, it becomes possible to reduce the adhesion of the adhering material to the electrode member disposed on the downstream side of the primary transfer portion and on the inner peripheral surface side of the intermediary transfer belt.

### Other Embodiments

As described above, the present invention has been described according to the specific Embodiments, however, the present invention is not limited to the Embodiments described above.

In the Embodiments described above, the potential regulating member (electrode member), of which the contact surface contacting the intermediary transfer belt is a flat surface, is a member having a plate shape formed of a sheet metal, etc., however, as long as a similar contact surface can be formed, it may be another form such as a member having a block shape of which cross-section is rectangular, for example. The same also applies to the potential regulating member (electrode member) of which the contact surface contacting the intermediary transfer belt is a curved surface. In addition, in the Embodiments described above, the potential regulating member is configured to include the first portion and the second portion, however, the potential regulating member may be constituted by, for example, a flat plate which corresponds to the first portion in the Embodiments described above.

In addition, in the Embodiments described above, the image forming apparatus is an image forming apparatus which is capable of forming a full-color image, however, the present invention is not limited thereto, but may be an image forming apparatus which is capable of forming only a monochrome (black and white or a mono-color) image.

In addition, in the Embodiments described above, the predetermined charging polarity of the photosensitive member is negative polarity, however, it is not limited thereto, but the predetermined charging polarity of the photosensitive member may be positive polarity. Similarly, in the Embodiments described above, the normal charging polarity of the toner is negative polarity, however, the normal charging polarity of the toner may be positive polarity. In a case in which the predetermined charging polarity of the photosensitive member and the normal charging polarity of the toner are positive polarity, the various types of applied voltages may be appropriately changed, according to the Embodiments described above, such as to an opposite polarity to that of the Embodiments described above.

In addition, the photosensitive member is not limited to the one having a drum shape (photosensitive drum), but may be one having an endless belt shape (photosensitive belt), etc.

In addition, in the Embodiments described above, the primary transfer member is the member having a roller shape, however, the primary transfer member may be a member having a brush shape, a member having a sheet shape, a member having a pad shape, etc.

In addition, in the Embodiments described above, the potential regulating power source is provided independently for each of the image forming units, however, the potential regulating power source may be commonized to a plurality (or all) of the image forming units. The same also applies to the charging power source, the developing power source and the primary transfer power source.

According to the present invention, it becomes possible to reduce the adhesion of the adhering material to the electrode member disposed on the downstream side of the primary transfer portion and on the inner peripheral surface side of the intermediary transfer belt.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-011011 filed on January 25, 2025, which is hereby incorporated by reference herein in its entirety.

What is claimed is:

1. An image forming apparatus comprising:
a photosensitive member capable of being electrically charged to a predetermined polarity and configured to bear a toner image;
an intermediary transfer belt stretched by a plurality of stretching rollers, configured to convey the toner image, primarily transferred from the photosensitive member in a primary transfer portion which is in contact with the photosensitive member, to secondarily transfer the toner image onto a recording material in a secondary transfer portion, and capable of being circulated and moved;
a primary transfer member configured to form the primary transfer portion by being in contact with an inner surface of the intermediary transfer belt, and configured to transfer the toner image from the photosensitive member onto the intermediary transfer belt in the primary transfer portion under application of a bias;
an electrode member provided on a side downstream of the primary transfer portion with respect to a movement direction of the intermediary transfer belt so as to be in contact with an inner surface of the intermediary transfer belt;
a power source configured to apply a bias of the same polarity as the predetermined polarity to the electrode member;
an inner surface cleaning member in contact with the inner surface of the intermediary transfer belt at an inner surface cleaning portion and configured to remove an adhering material from the inner surface of the intermediary transfer belt;
a driving portion configured to drive the intermediary transfer belt;
a contact/separation mechanism configured to move the electrode member between a first position to be in contact with the inner surface of the intermediary transfer belt and a second position not to be in contact with the inner surface of the intermediary transfer belt; and
a controller configured to control the driving portion and the contact/separation mechanism,
wherein the controller controls so as to start rotation of the intermediary transfer belt in a state in which the electrode member is caused to be in the second position when the controller causes the intermediary transfer belt to be rotated from a state in which the intermediary transfer belt is stopped.

2. The image forming apparatus according to claim 1, wherein in a case in which the controller rotates the intermediary transfer belt from a state in which the intermediary transfer belt is stopped in response to turning on of a power source of the image forming apparatus, the controller controls so as to start the rotation of the intermediary transfer belt in a state in which the electrode member is caused to be in the second position and the controller causes the electrode member to be moved from the second position to the first position after a rotation amount of the intermediary transfer belt reaches a predetermined rotation amount from starting the rotation of the intermediary transfer belt.

3. The image forming apparatus according to claim 1, wherein in a case in which the controller causes the intermediary transfer belt to be rotated from a state in which the intermediary transfer belt is stopped in response to input of a start instruction of image formation, the controller controls so as to start the rotation of the intermediary transfer belt in a state in which the electrode member is caused to be in the second position and the controller causes the electrode member to be moved from the second position to the first position after a rotation amount of the intermediary transfer belt reaches a predetermined rotation amount from starting the rotation of the intermediary transfer belt and before starting the image formation.

4. The image forming apparatus according to claim 1, wherein the controller is capable of controlling to execute an operation in a mode in which the inner surface of the intermediary transfer belt is cleaned by the inner surface cleaning member by rotating the intermediary transfer belt,
wherein an input portion configured to input a start instruction of the mode to the controller based on an operation of an operator is provided, and
wherein in a case in which the controller causes the intermediary transfer belt to be rotated from a state in which the intermediary transfer belt is stopped in response to input of the start instruction of the mode, the controller controls so as to start the rotation of the intermediary transfer belt in a state in which the electrode member is caused to be in the second position and the controller stops the rotation of the intermediary transfer belt in a state in which the electrode member is caused to be in the second position after a rotation amount of the intermediary transfer belt reaches a predetermined rotation amount.

5. The image forming apparatus according to claim 2, wherein the predetermined rotation amount is a rotation amount from starting the rotation of the intermediary transfer belt and until an area of the inner surface of the intermediary transfer belt, which has been in the inner surface cleaning portion at a timing of starting the rotation of the intermediary transfer belt, passes through a position where the area is in contact with the electrode member.

6. The image forming apparatus according to claim 2, further comprising a plurality of the photosensitive members, a plurality of the primary transfer members provided corresponding to the plurality of the photosensitive members, respectively, and a plurality of the electrode members provided corresponding to the plurality of the photosensitive members, respectively,
wherein the predetermined rotation amount is a rotation amount from starting the rotation of the intermediary transfer belt and until an area of the inner surface of the intermediary transfer belt, which has been in the inner surface cleaning portion at a timing of starting the rotation of the intermediary transfer belt, passes through a position where the area is in contact with the electrode member which is positioned downstreammost in the movement direction of the intermediary transfer belt.

7. The image forming apparatus according to claim 2, further comprising a plurality of the photosensitive members, a plurality of the primary transfer members provided corresponding to the plurality of the photosensitive members, respectively, and a plurality of the electrode members provided corresponding to the plurality of the photosensitive members, respectively,
wherein the predetermined rotation amount is a rotation amount from starting the rotation of the intermediary transfer belt and until an area of the inner surface of the intermediary transfer belt, which has been in the inner surface cleaning portion at a timing of starting the rotation of the intermediary transfer belt, passes through a position where the area is in contact with the stretching roller which is positioned in an immediately near downstream side of the electrode member which is positioned downstreammost in the movement direction of the intermediary transfer belt after the area passes through a position where the area is in contact with the electrode member which is positioned downstreammost in the movement direction.

8. The image forming apparatus according to claim 2, wherein the predetermined rotation amount is at least one full circumference of the intermediary transfer belt from starting the rotation of the intermediary transfer belt.

9. The image forming apparatus according to claim 2, wherein the controller is capable of changing the predetermined rotation amount based on information on a humidity of an environment.

10. The image forming apparatus according to claim 2, wherein the controller is capable of changing the predetermined rotation amount based on information on an accumulated usage amount of the intermediary transfer belt.

11. The image forming apparatus according to claim 2, wherein the controller is capable of changing the predetermined rotation amount based on information on an accumulated usage amount of the primary transfer member.

12. The image forming apparatus according to claim 1, wherein when the controller stops the rotation of the intermediary transfer belt from a state in which the electrode member is caused to be in the first position and the intermediary transfer belt is caused to be rotated, the controller controls so as to stop the rotation of the intermediary transfer belt after the electrode member is caused to be moved from the first position to the second position and the intermediary transfer belt is caused to be rotated in a state in which the electrode member is caused to be positioned in the second position.

13. The image forming apparatus according to claim 12, wherein when the controller stops the rotation of the intermediary transfer belt from the state in which the electrode member is caused to be in the first position and the intermediary transfer belt is caused to be rotated, the controller controls so as to stop the rotation of the intermediary transfer belt after a rotation amount of the intermediary transfer belt reaches a predetermined rotation amount from when the electrode member is caused to be in the second position.

14. The image forming apparatus according to claim 13, wherein the predetermined rotation amount is at least one full circumference of the intermediary transfer belt from when the electrode member is caused to be in the second position.

15. The image forming apparatus according to claim 13, wherein the controller is capable of changing the predetermined rotation amount based on information on a humidity of an environment.

16. The image forming apparatus according to claim 13, wherein the controller is capable of changing the predetermined rotation amount based on information on an accumulated usage amount of the intermediary transfer belt.

17. The image forming apparatus according to claim 13, wherein the controller is capable of changing the predetermined rotation amount based on information on an accumulated usage amount of the primary transfer member.

18. The image forming apparatus according to claim 1, further comprising a plurality of the photosensitive members, a plurality of the primary transfer members provided corresponding to the plurality of the photosensitive members, respectively, and a plurality of the electrode members provided corresponding to the plurality of the photosensitive members, respectively,
wherein the inner surface cleaning member is provided on a side downstream of the stretching roller which is positioned in an immediately near upstream side of the primary transfer member which is positioned upstreammost in the movement direction of the intermediary transfer belt and a side upstream of the primary transfer member which is positioned upstreammost in the movement direction.

19. The image forming apparatus according to claim 1, further comprising a cleaning device configured to remove an adhering material from an outer surface of the intermediary transfer belt in a single or a plurality of cleaning portions in a cleaning area in the movement direction of the intermediary transfer belt,
wherein the inner surface cleaning member is provided so as to contact the inner surface of the intermediary transfer belt corresponding to the cleaning area in the movement direction of the intermediary transfer belt.

20. The image forming apparatus according to claim 1, wherein the contact/separation mechanism moves the primary transfer member between a third position where the primary transfer member is in contract with the inner surface of the intermediary transfer belt and a fourth position where the primary transfer member is not in contract with the inner surface of the intermediary transfer belt, and
wherein the contact/separation mechanism causes the primary transfer member to be positioned at the third position when the electrode member is caused to be in the first position, and to be positioned at the fourth position when the electrode member is caused to be in the second position.
